(19) United States
(12) Patent Application Publication
(10) Pub. No.: US 2026/0212678 A1
(43) Pub. Date: Jul. 23, 2026

(54) ELECTRONIC DEVICE IMAGING AND DETECTION

(71) Applicant: Assurant, Inc., New York, NY (US)

(72) Inventors: Suresh Kumar NARAYANASAMY, New York, NY (US); Fnu ANKUR, New York, NY (US)

(21) Appl. No.: 19/432,722

(22) Filed: Dec. 24, 2025

Related U.S. Application Data
(60) Provisional application No. 63/740,855, filed on Dec. 31, 2024.

(51) Int. Cl. G06V 20/52; G06V 10/25; G06V 10/26; G06V 10/75; G06V 10/764; G06V 10/774; G06V 10/82; G06V 20/60

(52) U.S. Cl. CPC G06V 20/52; G06V 10/25; G06V 10/26; G06V 10/751; G06V 10/764; G06V 10/774; G06V 10/82; G06V 20/60; G06V 2201/06

(57) ABSTRACT

An example method may include positioning a package comprising a first plurality of electronic devices within a field-of-view of a first image capturing device; capturing at least one image of at least an interior of the package using the first image capturing device; applying one or more of the at least one image to a device detection model; receiving an expected electronic device count associated with the package; comparing the detected electronic device count and the expected electronic device count; and, in a first instance where the detected electronic device count and the expected electronic device count are equal, activate a package handling apparatus to transmit the package to a downstream station, and in a second instance where the detected electronic device count and the expected electronic device count are not equal, trigger an error condition. Systems, apparatuses, and computer readable media are also provided.

### CROSS-REFERENCE TO RELATED APPLICATION

This application claims the benefit of and priority to U.S. Provisional Application Ser. No. 63/740,855 filed Dec. 31, 2024, which application is incorporated by reference herein in its entirety.

### TECHNICAL FIELD

Embodiments of the present disclosure are generally directed to imaging and detection models and associated systems, apparatuses, and methods to detect objects such as electronic devices.

### BACKGROUND

Device processing systems require precise control and coordination between a number of different processing devices (e.g., robotic arms, conveyors, etc.). In high throughput environments, misplacing or misdirecting even one device may delay or halt the device processing system and may cause damage to the processing devices and/or the objects being processed. Traditional imaging systems cannot capture or process images rapidly or accurately enough to track objects in the device processing system. Applicant has discovered various technical problems associated with device processing systems. Through applied effort, ingenuity, and innovation, Applicant has solved many of these identified problems by developing the embodiments of the present disclosure, which are described in detail below.

### BRIEF SUMMARY

Embodiments of the present disclosure may include a computer-implemented method for determining a number of electronic devices. The method may include at least positioning a package including a first plurality of electronic devices within a field-of-view of a first image capturing device; capturing at least one image of at least an interior of the package using the first image capturing device; and applying one or more of the at least one image to a device detection model. The device detection model may be configured to output a detected electronic device count associated with the interior of the package. The method may further include, receiving an expected electronic device count associated with the package and comparing the detected electronic device count and the expected electronic device count. In a first instance where the detected electronic device count and the expected electronic device count are equal, a package handling apparatus may be activated to transmit the package to a downstream station. In a second instance where the detected electronic device count and the expected electronic device count are not equal, an error condition may be triggered.

In some embodiments, the method may include capturing a first image of at least an exterior of the package; analyzing the first image to identify a package identifier; and determining the expected electronic device count based on the package identifier.

In some embodiments, the package identifier may be a shipping label disposed on the exterior of the package.

In some embodiments, the device detection model may be trained to identify a particular make or model of electronic device, the particular make or model of electronic device corresponding to a make or model of the first plurality of electronic devices.

In some embodiments, the method may include storing one or more of the at least one image in association with the package identifier.

In some embodiments, the method may include capturing a plurality of images including the at least one image, via the first image capturing device. At least a portion of the plurality of images may be captured before positioning the package within the field-of-view of the first image capturing device and at least a second portion of the plurality of images may be captured after transmitting the package to the downstream station.

In some embodiments, the plurality of images may be applied sequentially to the device detection model, such that the device detection model outputs a sequence of detected electronic device counts associated with the interior of the package.

In some embodiments, the at least one image may include a plurality of images. The device detection model may include applying the plurality of images to the device detection model.

In some embodiments, the computer-implemented method may further include positioning the package including the first plurality of electronic devices within the field-of-view of a second image capturing device; capturing at least one second image of at least the interior of the package using the second image capturing device; and applying one or more of the at least one second image to the device detection model. The device detection model may be configured to output a second detected electronic device count associated with the interior of the package. The method may further include receiving a second expected electronic device count associated with the package and comparing the second detected electronic device count and the second expected electronic device count. In the first instance where the second detected electronic device count and the second expected electronic device count are equal, the package handling apparatus may be activated to transmit the package to the downstream station. In the second instance where the second detected electronic device count and the second expected electronic device count are not equal, the error condition may be triggered.

In some embodiments, positioning the package within the field-of-view of the first image capturing device includes positioning the package at a first location. A second location may be defined downstream of the first location at the downstream station or between the first location and the downstream station. The computer-implemented method may further include generating a plurality of images of the package while the package may be between the first location and the second location via the first image capturing device or a second image capturing device; and the applying one or more of the plurality of images to the device detection model to generate one or more additional detected electronic device counts.

In some embodiments, the first image capturing device may be positioned above a conveyor. In some embodiments, positioning the package within the field-of-view of the first image capturing device may include actuating the conveyor to move the package within the field-of-view of the first image capturing device.

In some embodiments, the method may include programmatically generating a plurality of device profile data objects associated with the first plurality of electronic devices detected in the detected electronic device count and printing a device ID label for each of the first plurality of electronic devices.

In some embodiments, the method may include masking the one or more of the at least one image to isolate the interior of the package before applying the one or more of the at least one image to the device detection model.

In some embodiments, the device detection model includes at least one convolutional neural network.

In some embodiments, the at least one convolutional neural network includes at least 24 convolutional layers.

In some embodiments, applying one or more of the at least one image to the device detection model may include passing the one or more of the at least one image through the at least one convolutional neural network to divide one or more of the at least one image into a grid of cells and generating a set of bounding boxes and class probabilities for each cell of the grid of cells.

In some embodiments, applying one or more of the at least one image to the device detection model further includes filtering the set of bounding boxes by removing at least one lower probability bounding box overlapping at least one higher probability bounding box to generate a set of predicted bounding boxes with class labels for each electronic device in the one or more of the at least one image.

In some embodiments, a first electronic device of the first plurality of electronic devices is overlapping a second electronic device of the first plurality of electronic devices, and the detected electronic device count may include counts representing both the first electronic device and the second electronic device.

In some embodiments, in the second instance, the method may include determining an actual electronic device count and updating a training of the device detection model based on the actual electronic device count and the one or more of the at least one image.

In some embodiments, the method may include a second image capturing device. The computer-implemented method may further include capturing at least one second image of at least the interior of the package using the second image capturing device while the package is within the field-of-view of the first image capturing device and a field-of-view of the second image capturing device; applying one or more of the at least one second image to the device detection model. The device detection model may output a second detected electronic device count associated with the interior of the package; and comparing the second detected electronic device count and the detected electronic device count.

In some embodiments, the method may include a second image capturing device defining a second field-of-view. The first image capturing device may be disposed at a first location and the second image capturing device may be disposed at a second location. The field-of-view includes a first station. The second field-of-view may include the downstream station. The method may further include capturing at least one second image of at least the interior of the package using the second image capturing device; applying one or more of the at least one second image to the device detection model. The device detection model may be configured to output a second detected electronic device count associated with the interior of the package. The method may further include comparing the second detected electronic device count and the detected electronic device count to verify a same number of electronic devices in the interior of the package.

In some embodiments, the method includes a second image capturing device defining a second field-of-view. The first image capturing device may be disposed at a first location and the second image capturing device may be disposed at a second location upstream of the first location. The field-of-view may include a first station. The second field-of-view may include an upstream station. The method may further include capturing at least one second image of at least the interior of the package using the second image capturing device; applying one or more of the at least one second image to the device detection model. The device detection model may output a second detected electronic device count associated with the interior of the package. The method may further include storing the second detected electronic device count as the expected electronic device count.

Embodiments of the present disclosure may include a system including at least one processor, and at least one non-transitory memory including computer-coded instructions thereon. The computer-coded instructions, with the at least one processor, may cause the system to position a package including a first plurality of electronic devices within a field-of-view of a first image capturing device, capture at least one image of at least an interior of the package using the first image capturing device, and apply one or more of the at least one image to a device detection model. The device detection model may be configured to output a detected electronic device count associated with the interior of the package; receive an expected electronic device count associated with the package; compare the detected electronic device count and the expected electronic device count. In a first instance where the detected electronic device count and the expected electronic device count are equal, the instructions may cause the system to activate a package handling apparatus to transmit the package to a downstream station. In a second instance where the detected electronic device count and the expected electronic device count are not equal, the instructions may cause the system to trigger an error condition.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will also be appreciated that the scope of the disclosure encompasses many potential embodiments in addition to those here summarized, some of which will be further described below.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein. To easily identify the discussion of any particular element or act, the most significant digit or digits in a reference number refer to the figure number in which that element is first introduced.

FIG. 1 is a diagram of an exemplary environment configured for detecting at least one electronic device associated with the interior of a package and handling the package in accordance with one or more embodiments of the present disclosure.

FIG. 2 is a block diagram of an exemplary apparatus structured in accordance with one or more embodiments of the present disclosure.

FIG. 3 illustrates an exemplary facility station in accordance with one or more embodiments of the present disclosure.

FIG. 4 illustrates an exemplary process flow diagram of a facility in accordance with one or more embodiments of the present disclosure.

FIG. 5 illustrates a flowchart representing a process for detecting at least one electronic device associated with the interior of a package via a device detection system in accordance with one or more embodiments of the present disclosure.

### DETAILED DESCRIPTION

Various embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. The terms “illustrative,” “example,” and “exemplary” are used to be examples with no indication of quality level or preference. In various examples, numerical terms (e.g., “first”, “second”, etc.) may be used to distinguish different versions of a particular type of entity for differentiation within the bounds of each given example and without implying a global distinction (e.g., a “first image” and a “second image” may each be examples of various “images” described herein and a “first image” of one example may be called an “image” or “second image” of another example without limiting the scope of the disclosure). Like numbers refer to like elements throughout.

### OVERVIEW

Device processing systems may be configured to perform various functions (e.g., refurbish, reformat, recondition, repair, redistribute, and/or otherwise process a mobile device) on electronic devices. The electronic devices may be in various states of operability and/or may include various programmatic interfaces that make direct electronic tracking difficult or otherwise prohibitive. Various embodiments herein include systems, apparatuses, processes, and related technology and operations for rapidly identifying the number of devices in an image (e.g., an image captured of the inside of a box) captured by image capturing devices and for tracking and monitoring a count of devices in various locations throughout the system. For example, in some instances, it is desirable to know how many electronic devices are entering a facility to detect any devices lost during transport or never sent to the facility. In some embodiments of the present disclosure, the system may need to verify a device count in one or more locations along the device processing system.

In high-volume facilities, errors associated with counting the number of electronic devices received from a large-volume distributor or verifying the accuracy of a shipment (e.g., in one or more packages of multiple devices) may be eliminated via embodiments of the present disclosure. For example, a high-volume processing facility may include various processing stations positioned in various locations throughout the facility, and devices may be processed serially through one or more of the stations. In some instances, misplacing or miscounting the electronic devices may shut down an entire device processing system and/or disrupt downstream stations from the location where the device was misplaced or miscounted (e.g., by causing an error in the system when a station tries to process or fails to process an unexpected device when a device count is off).

Various embodiments may include a system for controlling aspects of the device processing system to verify the number of electronic devices at one or more predetermined verification points along the device processing flow, which may facilitate tracking of the devices and handoff between the various processing machines within the system. For example, various embodiments may be configured to verify that the devices are accounted for, that the correct device is feeding into one or more portions of the system, and that a chain of visual recognition is used to connect discrete touch points within the system so that there are no or reduced device continuity losses. Moreover, in some embodiments, various performance parameters (e.g., throughput) and/or faults (e.g., defective device processing machines) may be detected by the imaging processes discussed herein.

In some embodiments, the system may compare a number of electronic devices detected in an image (e.g., within a package captured in an image) to an expected device count to verify that the system is operating correctly and/or that the package (or other arrangement of one or more device(s)) is correctly identified. If an inconsistency is detected at any point in the process, an error condition may be triggered. The system may rapidly localize the error to the exact location (e.g., station), package, or device (or lack thereof) that triggered the error condition. Similarly, the system may be configured to reroute the various other devices in the device processing flow, adjust the processing flow to account for the error (e.g., increment the device processing flow count to ensure that the detected devices are in known positions and operations are being performed on the correct devices), shut down one or more stations, and/or keep non-affected stations operational to minimize impact on the device processing system while avoiding errors associated with misplaced or misidentified devices. In an example embodiment, the incorrect device count from the initial imaging and/or a subsequent imaging process may trigger an error condition. The image capturing devices may store (e.g., via a repository) a video stream and/or individual images of packages being inspected for visual fraud protection and data consistency, for example, in an instance in which the package contains a number of devices other than what the sender claims.

Various embodiments include improved image processing models and techniques for rapidly identifying one or more electronic devices in an image. For example, some embodiments of the present disclosure include distributed imaging systems and corresponding analysis tools to count devices within the field of view or a portion thereof of each of a plurality of image capturing devices. The present disclosure includes various imaging devices, device detection models, and corresponding processing circuitry configured to capture an image and rapidly count the number of electronic devices in the image. In some embodiments, the count may be continuously output as successive images (e.g., in a captured video) are taken. The system may be configured to mask certain areas of a field of view of the image to analyze a predetermined area. The various models disclosed herein also solve existing problems associated with image analysis by counting devices regardless of their orientation or position in the imaged area. In some embodiments, more specific image analyses may be performed (e.g., device identification, orientation detection, etc.). Combined with the aforementioned tracking systems and processes, the improved imaging devices and image analysis processes discussed herein may be used to continuously or periodically monitor the locations of high volumes (e.g., thousands or millions) of devices within a facility.

The aforementioned device processing systems may use one or more control systems, which may control various devices, such as an image capturing device and/or one or more conveyor systems, stations, carts, or the like to manipulate and control the identification and processing flow of electronic devices by coordinating the device processing machines and accurately and rapidly counting and, in some embodiments, tracking each of the electronic devices. Existing control systems suffer from numerous deficiencies associated with detecting electronic devices (e.g., devices in an interior of a package, devices laying atop each other, etc.). In this regard, Applicant has addressed these and other technical problems by inventing various methods, systems, and apparatuses capable of one or more operations disclosed herein, including but not limited to solving each of the foregoing deficiencies, both alone and in various combinations.

### Definitions

As used herein, the term “device detection system” refers to a system comprising hardware, software, or a combination of hardware and software configured to identify the number of electronic devices associated with the interior of a package and based on the detection of the electronic devices associated with the interior of a package, control the pathway of the package. In some embodiments the device detection system may include one or more electronic device detection computing devices, one or more image capturing devices, one or more gantries, one or more conveyor belts, one or more data repositories, and/or computer-coded instructions (e.g., one or more software applications) that are configured for execution via the one or more computing devices and/or stored in one or more data repository(s). The electronic device detection computing devices may, in conjunction with the various other components associated with the device detection system, facilitate the execution of an electronic device detection model for a respective package, location, or other area of interest. In one or more embodiments, the various software and/or hardware components of the device detection system may communicate via one or more networks. For example, the one or more image capturing devices, the device detection model, and/or one or more non-transitory memory can communicate via one or more networks to position a package comprising a first plurality of one or more electronic devices within a field-of-view of a first image capturing device. In some embodiments, at least one image of at least an interior of the package is captured using the first image capturing device that is applied to a device detection model. The device detection system may additionally or alternatively capture an image of one or more electronic devices outside of a package (e.g., on a surface, table, conveyor, cart, processing machine, or the like) for processing (e.g., counting, analysis, and/or tracking) in accordance with the various embodiments discussed herein. A device detection system may form a portion of a device processing system.

In various contexts, the device detection system can be embodied by an enterprise-scale logistics system configured to assess, diagnose, recondition, refurbish, reformat, repair, and/or otherwise manage various functions associated with one or more objects of interest, such as, for example, one or more packages containing the one or more electronic devices; one or more surfaces, tables, conveyors, carts, processing machines, or the like supporting the electronic devices; other surfaces containing one or more electronic devices; and/or the like. In one or more contexts, the device detection model outputs a detected electronic device count associated with the interior of the package or other area within the field of view of an image capturing device, receives an expected electronic device count associated with the package, and/or compares the detected electronic device count and the expected electronic device count. In a first instance where the detected electronic device count and the expected electronic device count are equal, a package handling apparatus is activated to transmit the package to a downstream station. In a second instance where the detected electronic device count and the expected electronic device count are not equal, an error condition is triggered. In various contexts, the electronic devices associated with the interior of the of the package can be composed of various materials including, but not limited to, glass, plastic, rubber, vinyl, composite materials, aluminum, wood, and/or the like. As such, the device detection system is configured to analyze a plurality of objects in image data, which objects are constructed in various materials to identify a number of electronic devices present in the interior of the package.

As used herein, the term “electronic device detection model” and “device detection model” interchangeably refer to an algorithmic, statistical, rules-based, machine learning, and/or other model configured to be executed by hardware, software, or a combination of hardware and software configured to detect, calculate, extract, and/or otherwise determine particular data from image data. The device detection model may comprise one or more such sub-models or related programming for carrying out one or more functions. For example, a device detection model may be configured to analyze one or more images to detect one or more electronic devices therein. In some embodiments, a device detection model may generate one or more data values associated with the electronic device, including make, model, size, shape, orientation, quantity (e.g., device count), coordinate location, and/or the like. In some embodiments, a device detection model may be configured to detect electronic devices within a captured image or a portion thereof. The device detection model may output one or more of the aforementioned datapoints (e.g., a device count) in response to receiving an image as an input. In some embodiments, at least one image of at least an interior of the package is captured using the first image capturing device and the at least one image is applied to a device detection model. In some embodiments, the device detection model outputs a detected electronic device count associated with the interior of the package, receives an expected electronic device count associated with the package, and compares the detected electronic device count and the expected electronic device count. In a first instance where the detected electronic device count and the expected electronic device count are equal, a package handling apparatus is activated to transmit the package to a downstream station. In a second instance where the detected electronic device count and the expected electronic device count are not equal, an error condition is triggered.

In some embodiments, a device detection model may operate in or with one or more device processing systems and device detection systems in accordance with various embodiments discussed herein. The data generated by a device detection model may be used to control various other processes of the aforementioned systems (e.g., camera control, conveyor control, etc.). In some embodiments, a computing device using or in communication with a device detection model may execute one or more commands that cause the system to manipulate a particular object (e.g., a package, one or more electronic devices, etc.) such that one or more processes may be performed on the particular object (e.g., one or more image data capturing processes, one or more conveyor processes, or the like) for facilitating the image capture and analysis processes discussed herein.

As used herein, the terms “image capturing device”, “imager”, “imaging device”, and the like interchangeably refer to a device configured to capture one or more portions of image data, including image data related to, but not limited to, the interior of a package. An image capturing device may include a camera (e.g., a photographic camera including cameras capable of capturing various wavelengths of the electromagnetic spectrum, such as but not limited to visible, IR, NIR, and/or ultraviolet light; a LIDAR camera; or any other device capable of imaging the object for one or more of the respective functions described herein). In various contexts, the image capturing device can capture one or more types of image data including, but not limited to, one or more images (e.g., individual or a plurality of still photos), one or more bursts images (e.g., a predetermined number of still images captured in sequence), and/or one or more videos (e.g., sequentially captured images). In some embodiments, a package is positioned within a field-of-view of a first image capturing device with the package including electronic devices for counting therein. For example, an image capturing device (e.g., a first image capturing device) captures at least one image of at least the interior of the package. In some embodiments, the first image capturing device captures an image of at least an exterior of the package to identify a package identifier in addition to or instead of capturing an image of the interior of the package. In some embodiments, a second image capturing device, such as a code reader (e.g., a bar code scanner), may capture a package identifier on the exterior of the device. In some embodiments, the individual electronic devices may include one or more identifiers (e.g., QR codes) which may be captured by one or more image capturing devices, such as to identify devices at a particular location and/or associate specific devices with a device count generated in accordance with various embodiments herein. Similarly, in some embodiments, an image capturing device may capture images of loose electronic devices or electronic devices in or on another apparatus (e.g., within a processing machine of one or more stations).

Various capturing processes may be used, such as continually capturing images and outputting a count associated with the image data for all or a portion of the images with or without regard to whether a package or electronic device(s) are within the field of view of a camera (e.g., capturing images before and after a package is positioned at a processing station). In some embodiments, a trigger (e.g., a sensor, such as a laser, or a manual trigger) may cause an image capturing device to capture an image. Various post-processing operations may be performed on the image data, such as masking, histogram analysis, or the like. In some embodiments, a subset of an image may be analyzed to detect electronic devices.

As used herein, the terms “detected electronic device count”, “detected device count”, and the like refer to a numerical value associated with the number of electronic devices in one or more images. The detected electronic device count may be generated via one or more computer vision (e.g., machine vision) algorithms applied to the image(s). In some embodiments, a detected electronic device count may be used to generate an expected electronic device count or similar data value for another workflow. In various embodiments, the device detection system utilizes an electronic device detection model in order to generate the detected electronic device count. The detected electronic device count may be associated with a particular area (e.g., a region within a facility) or a particular portion of an image, such as the interior of a package.

As used herein, the term “expected electronic device count” refers to a numerical value representing a predetermined, predicted, or otherwise stored electronic device count. For example, a device detection system or another repository may store one or more expected electronic device counts in association with a package identifier, a processing machine, a production line, or another identifier or area. The device detection system may use the electronic device detection model to complete various tasks such as, for example, comparing the expected electronic device count and the detected electronic device count. In a first instance where the detected electronic device count and the expected electronic device count are equal, a package handling apparatus is activated to transmit the package to a downstream station. In a second instance where the detected electronic device count and the expected electronic device count are not equal, an error condition may be triggered.

As used herein, the term “package” refers to any physical structure capable of holding one or more electronic devices. In some embodiments, a package may refer to a box or similar container for shipping electronic devices. In such instances, the package may be opened by lifting a lid and/or one or more flaps to view the contents thereof. In some embodiments, a package may refer to a tray, bin, or the like having an open or closed top. The package may be configured to hold a plurality of electronic devices as an image capturing device counts the electronic devices (e.g., during an intake process of a facility workflow prior to analyzing the electronic devices).

As used herein, the term “package identifier” refers to any data value or other indicia in physical and/or electronic form configured to identify (whether uniquely or not) a package. For example, a package identifier may be the shipping label disposed on the exterior of the package, a portion thereof, or a readable indicia thereon. The package identifier may be associated with an expected electronic device count that may be read directly from the package identifier or retrieved from a repository using the package identifier. The term package identifier should be understood to encompass any identifier that facilitates linking the expected device count with the package or other media on which the identifier is captured (e.g., an account number, a confirmation code, etc.). In some embodiments, an image is captured of at least an exterior of the package. In some embodiments, the image is analyzed to identify a package identifier. In some embodiments, the expected electronic device count is determined based on the package identifier.

As used herein, the term “error Condition” refers to any output indicative of a detected device count being inconsistent with an expected device count or a similar output associated with one or more electronic devices being in an unexpected location or not in an expected location. In some embodiments, the error condition may be generated by the device detection system or an associated system. In some embodiments, based on an error condition, one or more electronic device(s) and/or packages are transmitted to a parallel workstation or otherwise removed from a station or location for further inquiry.

As used herein, the terms “data,” “content,” “digital content,” “digital content object,” “information,” and similar terms may be used interchangeably to refer to data capable of being transmitted, received, created, modified, and/or stored in accordance with examples of the present disclosure. Thus, use of any such terms should not be taken to limit the spirit and scope of examples of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like (sometimes referred to herein as a “network”). Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

As used herein, the term “circuitry” refers broadly to include hardware and, in some examples, software for configuring the hardware. With respect to components of the apparatus, the term “circuitry” as used herein should therefore be understood to include particular hardware configured to perform the functions associated with the particular circuitry as described herein. For example, in some examples, “circuitry” may include processing circuitry, storage media, network interfaces, input/output devices, and the like.

As used herein, the terms “executable code,” “computer-coded instructions,” and the like refer interchangeably to one or more portions of computer program code storable and/or stored in one or a plurality of locations that is executed and/or executable via one or more computing devices embodied in hardware, software, firmware, and/or any combination thereof. Executable code may define at least one particular operation to be executed by one or more computing devices. In some embodiments, a memory, storage, and/or other computing device includes and/or otherwise is structured to define any amount of executable code (e.g., a portion of executable code associated with a first operation and a portion of executable code associated with a second operation). Alternatively, or additionally, in some embodiments, executable code is embodied by separate computing devices (e.g., a first data store embodying first portion of executable code and a second data store embodying a second portion executable code). In some embodiments, executable code requires one or more processing steps (e.g., compilation) prior to being executed by a computing device.

As used herein, the terms “data store,” “storage,” “memory,” and the like refer interchangeably to any type of non-transitory computer-readable storage medium. Non-limiting examples of a data store include hardware, software, firmware, and/or a combination thereof capable of storing, recording, updating, retrieving and/or deleting computer-readable data and information, whether embodied locally and/or remotely and whether embodied by a single hardware device and/or a plurality of hardware devices.

As used herein, the term “device profile data object” refers to an electronically managed data structure representing a collection of one or more data attributes and/or portions of executable code. For example, in some embodiments, the data profile data object stores a record of an electronic device as it moves through the facility.

As used herein, the term “computing device” refers to any computer, processor, circuitry, and/or other executor of computer instructions that is embodied in hardware, software, firmware, and/or any combination thereof. A computing device may enable access to a myriad of functionalities associated with one or more mobile device(s), other computing devices, system(s), and/or one or more communications networks. Non-limiting examples of a computing device include a computer, a processor, an application-specific integrated circuit, a field-programmable gate array, a personal computer, a smart phone, a laptop, a fixed terminal, a server, a networking device, and a virtual machine.

As used herein, the term “electronic device” refers to any portable computing device, such as, but not limited to, a portable digital assistant (PDA), mobile telephone, smartphone, or tablet computer with one or more communications, networking, and/or interfacing capabilities. Non-limiting examples of communications, networking, and/or interfacing capabilities include CDMA, TDMA, 4G, 5G, NFC, Wi-Fi, Bluetooth, as well as hard-wired connection interfaces such as USB, Thunderbolt, and/or ethernet connections. While various embodiments of the present disclosure refer to “electronic devices”, such as in the context of a device detection model, it should be understood that other objects may be imaged and analyzed in addition to or instead of the electronic devices.

### EXAMPLE SYSTEMS AND APPARATUSES OF THE DISCLOSURE

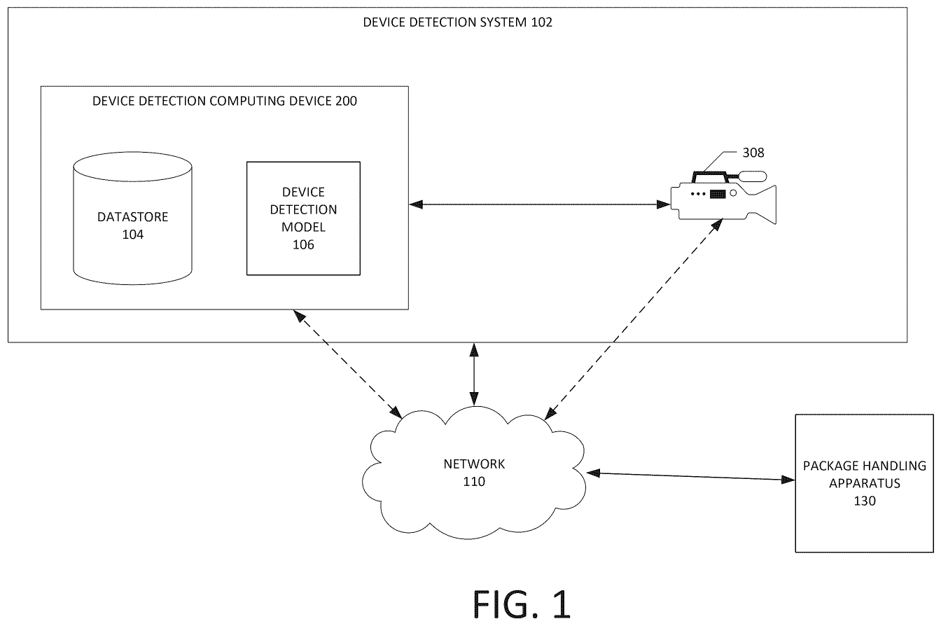

FIG. 1 is a diagram of an exemplary environment configured for detecting a first plurality of one or more electronic devices associated with the interior of a package in accordance with one or more embodiments of the present disclosure. The exemplary environment includes a device detection system 102 capable of analyzing images in accordance with various embodiments of the present disclosure, such as determining the number of devices within a package and/or within a field of interest or field-of-view of an image capturing device 308. The device detection system 102 is capable of imaging and analyzing a package and/or one or more electronic devices in the field-of-view of an image capturing device to determine the number of electronic devices within the field-of-view and based on the determination, transmit the package to a next station. The device detection system may, in some embodiments, generate various outputs including a raw count and/or additional computer-executable instructions. As described herein, the various components of the device detection system 102 are configured to execute a device detection model 106 to cause and/or facilitate the detection of electronic devices, such as may be associated with the interior of a package.

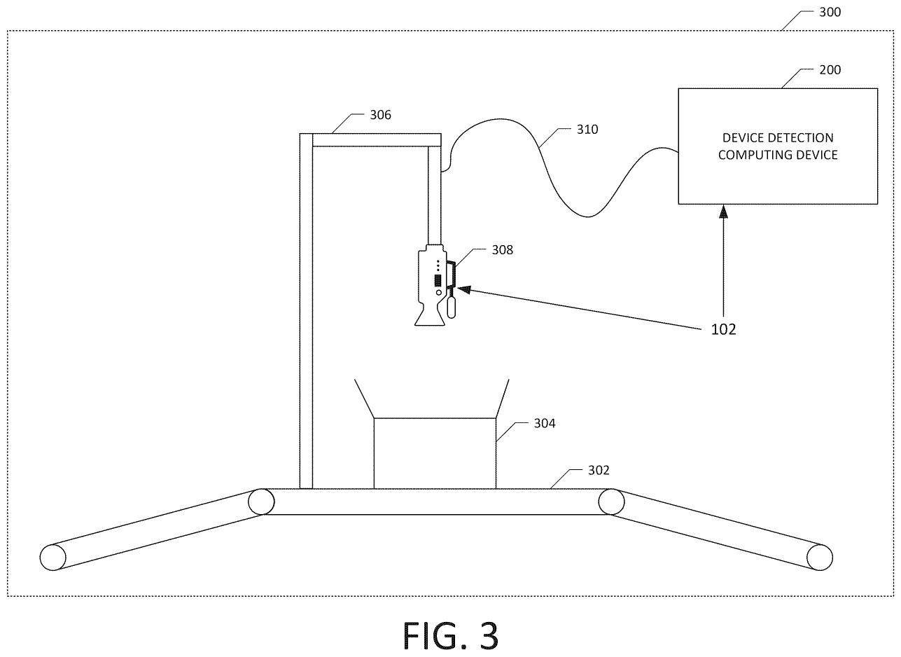

The exemplary environment includes a device detection system 102 associated with the datastore 104 and the device detection model 106, the network 110, the image capturing device 308, and the package handling apparatus 130 (e.g., conveyor 302 illustrated in FIG. 3) configured to facilitate the execution of the various functions described herein. In one or more embodiments, a package may include one or more electronic devices such as, but not limited to, a smartphone, another type of mobile telephone, a laptop, a portable digital assistant (PDA), a tablet computer, or the like with one or more communications, networking, and/or interfacing capabilities. In some embodiments, the electronic device(s) may be disposed on a surface, table, conveyor, cart, processing machine, or the like and captured in one or more images.

The device detection system 102 may include hardware, software, or a combination of hardware and software configured to identify the number of electronic devices in one or more images and/or perform various other analyses associated wit the image. In some embodiments, the device detection system 102 may be configured to generate a count associated with one or more electronic devices in the interior of a package. Based on the detection of the electronic devices associated with the interior of a package, the device detection system 102 or another connected system may be configured to control the pathway of the package through a facility system, also referred to as a device processing system, warehouse, processing system, or the like (e.g., between multiple stations of the system).

In some embodiments the device detection system may include one or more device detection computing devices 200, one or more image capturing devices (e.g., image capturing device 308), one or more mounting apparatuses, one or more conveyors, one or more data repositories 104, and/or computer-coded instructions (e.g., one or more software applications) that may be configured for execution via the one or more computing devices and/or stored in one or more data repository(s). The device detection computing devices 200 may, alone or in conjunction with the various other components associated with the device detection system 102, facilitate the execution of a device detection model 106 for a respective area of interest (e.g., within a field of view of an image capturing device or a portion thereof, including but not limited to the interior of a package). In one or more embodiments, the various software and/or hardware components of the device detection system 102 may communicate via one or more networks. For example, the one or more image capturing devices 308, one or more device detection models 106, one or more package handling apparatuses 130, and/or one or more non-transitory memory can communicate via one or more networks 110 to position a package comprising a first plurality of one or more electronic devices (or in some embodiments the electronic devices without a package) within a field-of-view of an image capturing device 308, capture an image of the one or more electronic devices, analyze the image, and/or perform subsequent device handling operations via network communications. In some embodiments, at least one image of at least an interior of the package is captured using an image capturing device 308 that is applied to a device detection model 106. The image capturing device(s) 308 may be considered part of or separate from the device detection system 102.

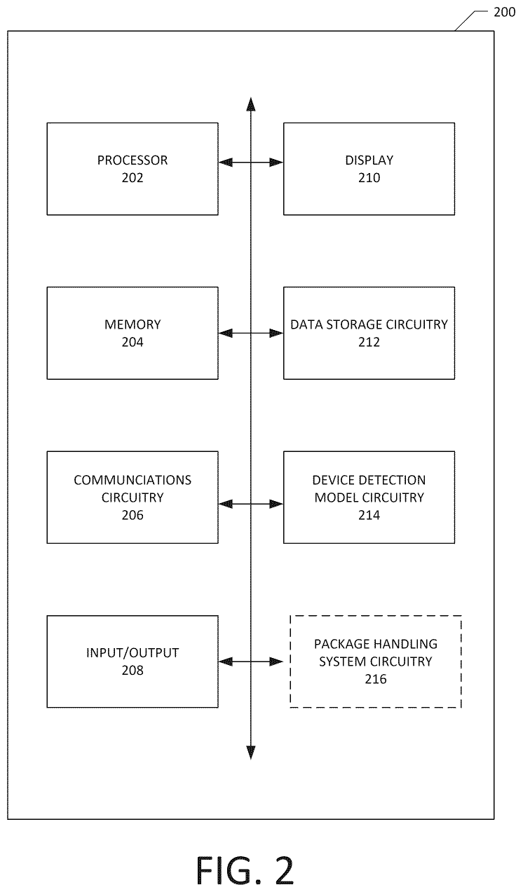

The depicted device detection system 102 also comprises a datastore 104 used in accordance with various embodiments of the present disclosure. The datastore 104 can be any configuration of non-transitory computer-readable storage medium. Non-limiting examples of a datastore include hardware, software, firmware, and/or a combination thereof capable of storing, recording, updating, retrieving and/or deleting computer-readable data and information. For example, the datastore 104 can contain one or more computer program command sequences to be executed by a device detection computing device (e.g., device detection computing device 200) in order to determine the number of electronic devices associated with the interior of a package or another area of interest. In some embodiments, the memory incorporated with the computing device (e.g., memory 204 shown in FIG. 2) comprises the one or more computer program command sequences comprising computer-executable instructions to be executed by the device detection computing device 200. In some embodiments, the datastore 104 and the device detection computing device 200 are part of the same computing device. In some embodiments, the datastore 104 and the device detection computing device 200 are distinct devices connected via wired or wireless connection, or a combination thereof, including via one or more networks. Additionally, or alternatively, the datastore 104 may be used to store, update, and maintain the image data captured by an image capturing device associated with the device detection system 102 and/or any continuous images generated based on image data related to an edge of a package.

In various embodiments, the network 110 shown in connection with the device detection system 102 may be any suitable network or combination of networks and supports any appropriate protocol suitable for communication of data to and from components of the device detection system 102. In some embodiments, the network 110 may connect the components of the device detection system 102 with one or more external computing devices, including, but not limited to, one or more mobile devices. According to various embodiments, the network 110 may include a public network (e.g., the Internet), a private network (e.g., a network within an organization), or a combination of public and/or private networks. According to various embodiments, the network 110 is configured to provide communication between various systems and apparatuses depicted in FIG. 1 (e.g., device detection computing device 200 and/or datastore 104) and/or one or more additional systems or apparatuses. According to various embodiments, network 110 can comprise one or more networks that connect devices and/or components in the network layout to allow communication between the devices and/or components. For example, the network 110 can be implemented as the Internet, a wireless network, a wired network (e.g., Ethernet), a local area network (LAN), a Wide Area Network (WANs), Bluetooth, Near Field Communication (NFC), Worldwide Interoperability for Microwave Access (WiMAX) network, a personal area network (PAN), a short-range wireless network (e.g., a Bluetooth® network), an infrared wireless (e.g., IrDA) network, an ultra-wideband (UWB) network, an induction wireless transmission network, and/or any other type of network that provides communications between one or more components of the network layout. In some embodiments, network 110 is implemented using cellular networks, satellite, licensed radio, or a combination of cellular, satellite, licensed radio, and/or unlicensed radio networks. In one or more embodiments, the communications circuitry 206 comprised in the device detection computing device 200 can transmit and receive data to and from the device detection system 102 via the network 110.

As described herein, in some embodiments, the image capturing device 308 may be or may include a camera configured to image the one or more electronic devices or other objects within the field of view of the camera, such as the interior of a package and or a grouping of electronic devices present at a station within a facility (e.g., the electronic devices associated with the interior of the package and/or the electronic devices at a certain station of the facility that are no longer contained within the original package but are grouped together). The camera image may be used by the device detection system 102 to detect the number of electronic devices within the package or other area and compare the detected number of electronic devices with the expected number of electronic devices in some embodiments.

The package handling apparatus 130 may be any mechanical manipulation device capable of engaging the package and/or grouping of electronic devices and manipulating the object by translating, rotating, and/or otherwise moving the package with respect to one or more axes and/or moving the conveyor system according to some embodiments. In some embodiments, the package handling apparatus may be configured to operable engage a package with a conveyor to facilitate the execution of the device detection operation.

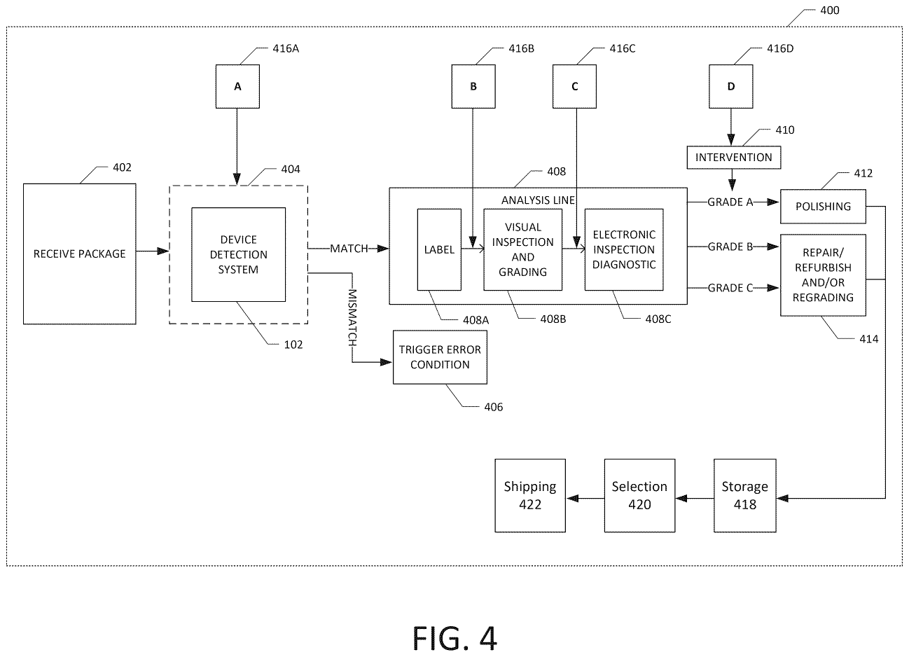

FIG. 2 illustrates a block diagram of an example apparatus according to one or more embodiments of the disclosure. The apparatus depicted in FIG. 2 may represent a device detection computing device 200 configured to facilitate executing a device detection operation with respect to one or more electronic devices (e.g., devices captured in an image defined by a field of view of an image capturing device, such as electronic devices in a particular package and/or station in accordance with at least some example embodiments of the present disclosure. Various other computing devices herein may utilize the same apparatus structure (e.g., any of the devices at the various analysis stations 408, polishing station 412, repair/refurbish/regrade station(s) 414, or any other station shown in FIG. 4 as non-limiting examples). The device detection computing device 200 may include a processor 202, a memory 204, communications circuitry 206, input/output circuitry 208, display 210, data storage circuitry 212, device detection model circuitry 214, and/or package handling system circuitry 216. Additionally, or alternatively, the device detection computing device 200 may be in other form(s) and/or may comprise other component(s).

In general, the terms computing device, system, entity, and/or similar words used herein interchangeably may refer to, for example, one or more electronic devices, computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the device detection computing device 200 embodies a particular, specially configured computing system transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. In some embodiments, other elements of the device detection computing device 200 provide or supplement the functionality of another particular set of circuitry. For example, the processor 202 in some embodiments provides processing functionality to any of the sets of circuitry, the memory 204 provides storage functionality to any of the sets of circuitry, the communications circuitry 206 provides network interface functionality to any of the sets of circuitry, and/or the like.

The processor 202 may be embodied in a number of different ways and may, for example, include one or more processing devices configured to perform independently. Additionally, or alternatively, the processor 202 may include one or more processors configured in tandem via a bus to enable independent execution of instructions, pipelining, and/or multithreading. Additionally, in some embodiments, the processor 202 may include one or processors, some which may be referred to as sub-processors, to control one or more components, modules, or circuitry of device detection computing device 200.

The processor 202 may be embodied as one or more complex programmable logic devices (CPLDs), microprocessors, multi-core processors, co-processing entities, application-specific instruction-set processors (ASIPs), and/or controllers. Further, the processor 202 may be embodied as one or more other processing devices or circuitry. The term circuitry may refer to a hardware embodiment or a combination of hardware and computer program products. Thus, the processor 202 may be embodied as integrated circuits, application specific integrated circuits (ASICs), field programmable gate arrays (FPGAs), programmable logic arrays (PLAs), hardware accelerators, another circuitry, and/or the like. As will therefore be understood, the processor 202 may be configured for a particular use or configured to execute instructions stored in volatile or non-volatile media or otherwise accessible to the processor 202. As such, whether configured by hardware or computer program products, or by a combination thereof, the processor 202 may be capable of performing steps or operations according to embodiments of the present disclosure when configured accordingly.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, the processor may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor to perform the algorithms and/or operations described herein when the instructions are executed.

In some embodiments, the memory 204 may be non-transitory and may include, for example, one or more volatile and/or non-volatile memories. In other words, for example, the memory 204 may be an electronic storage device (e.g., a computer readable storage medium). The memory 204 may be configured to store information, data, content, applications, instructions, or the like, for enabling the device detection computing device 200 to conduct various functions in accordance with example embodiments of the present disclosure. In this regard, the memory 204 may be preconfigured to include computer-coded instructions (e.g., computer program code), and/or dynamically be configured to store such computer-coded instructions for execution by the processor 202.

In an example embodiment, the electronic device detection computing device 200 further includes a communications circuitry 206 that may enable the electronic device detection computing device 200 to transmit data and/or information to other devices or systems through a network (such as, but not limited to, the various device processing machines at the various stations shown and described with respect to FIG. 4). The communications circuitry 206 may be any means such as a device or circuitry embodied in either hardware or a combination of hardware and software that is configured to receive and/or transmit data from/to a network and/or any other device, circuitry, or module in communication with the device detection computing device 200. In this regard, the communications circuitry 206 may include, for example, a network interface for enabling communications with a wired (e.g., Serial, Ethernet, or the like) or wireless (e.g., Wi-Fi, Bluetooth, or the like) communication network. For example, the communications circuitry 206 may include one or more circuitries, network interface cards, antennae, buses, switches, routers, modems, and supporting hardware and/or software, or any other device suitable for enabling communications via a network. Additionally, or alternatively, the communication interface may include the circuitry for interacting with the antenna(s) to cause transmission of signals via the antenna(s) or to handle receipt of signals received via the antenna(s).

In some embodiments, the device detection computing device 200 includes input/output circuitry 208 that may, in turn, be in communication with the processor 202 to provide output to the user and, in some embodiments, to receive an indication of a user input. The input/output circuitry 208 may comprise an interface or the like. In some embodiments, the input/output circuitry 208 may include a keyboard, a mouse, a joystick, a touch screen, touch areas, soft keys, a microphone, a speaker, or other input/output mechanisms. The processor 202 and/or input/output circuitry 208 may be configured to control one or more functions of one or more user interface elements through computer program instructions (e.g., software and/or firmware) stored on a memory accessible to the processor (e.g., memory 204). The processor 202 and/or input/output circuitry 208 may also be configured to control one or more image capturing devices integrated by the device detection system 102.

In some embodiments, the device detection computing device 200 includes a display 210 that may, in turn, be in communication with the processor 202 to display user interfaces (such as, but not limited to, display of a call and/or an application). In some embodiments of the present disclosure, the display 210 may include a liquid crystal display (LCD), a light-emitting diode (LED) display, a plasma (PDP) display, a quantum dot (QLED) display, and/or the like.

In some embodiments, the device detection computing device 200 includes the data storage circuitry 212 which comprises hardware, software, firmware, and/or a combination thereof, that supports functionality for generating, storing, and/or maintaining one or more data objects associated with the device detection system 102. For example, in some embodiments, the data storage circuitry 212 includes hardware, software, firmware, and/or a combination thereof, that stores data related to image data captured by an image capturing device in a datastore (e.g., datastore 104 shown in FIG. 1). Additionally, or alternatively, the data storage circuitry 212 also stores and maintains data related to one or more expected electronic device counts or detected electronic device counts in the datastore 104. Additionally, or alternatively still, the data storage circuitry 212 may store and maintain training data for a detection model with the device detection system 102 in the datastore 104 (e.g., labeled training data for training a machine learning model, such as by structured learning). In some embodiments, the data storage circuitry 212 can be integrated with, or embodied by, the datastore 104. In some embodiments, the data storage circuitry 212 includes a separate processor, specially configured field programmable gate array (FPGA), or a specially programmed application specific integrated circuit (ASIC).

In some embodiments, the device detection computing device 200 includes device detection model circuitry 214 which comprises hardware, software, firmware, and/or a combination thereof, that supports functionality for detecting the number of electronic devices associated with a package. In one or more embodiments, the electronic device detection model circuitry 214 works in conjunction with the processor 202 and one or more components of the device detection computing device 200 to cause execution of the device detection system with respect to a package and the electronic devices associated with the interior of the package. For example, the device detection model circuitry 214 in conjunction with the processor 202 and/or the communications circuitry 206 can compare the expected electronic device count and the detected electronic device count. In a first instance where the detected electronic device count and the expected electronic device count are equal, a package handling apparatus is activated to transmit the package to a downstream station. In a second instance where the detected electronic device count and the expected electronic device count are not equal, an error condition is triggered.

In some embodiments, the device detection computing device 200 includes package handling system circuitry 216 which comprises hardware, software, firmware, and/or a combination thereof, that supports functionality for transmitting a package by the conveyor belt. In the depicted embodiment, the device detection computing device 200 includes the package handling system circuitry 216 therein, and in some embodiments (e.g., as shown in FIG. 1), the package handling apparatus 130 and corresponding circuitry may be separate from the device detection system 120. In some embodiments, image data related to the interior of a package is captured, the detected electronic device count from the captured image data is generated, the detected electronic device count and the expected electronic device count are compared, and the package is transmitted. In this regard, the package handling apparatus circuity 216 can direct the package by controlling one or more robotic arms, motors, actuators, and/or the like. In embodiments in which the electronic devices are handled separately from a package, the package handling apparatus and package handling system circuitry may be replaced with electronic device handling apparatuses and electronic device handling system circuitry in any embodiment disclosed herein.

In some embodiments, two or more of the sets of circuitries 202-216 are combinable. Additionally, or alternatively, in some embodiments, one or more of the sets of circuitry perform some or all of the functionality described associated with another component. For example, in some embodiments, two or more of the sets of circuitries 202-216 are combined into a single module embodied in hardware, software, firmware, and/or a combination thereof. Similarly, in some embodiments, one or more of the sets of circuitries, for example the communications circuitry 206, the data storage circuitry 212, the device detection model circuitry 214, the package handling system circuitry 216 is/are combined with the processor 202, such that the processor 202 performs one or more of the operations described above with respect to each of these sets of circuitries 202-216. Moreover, in some embodiments, multiple apparatuses 200 may be used to each perform various subsets of the functions discussed herein (e.g., a first apparatus for image capture, a second apparatus for image analysis, and/or a third apparatus for package handling system control).

FIG. 3 illustrates an exemplary facility processing station 300 configured to carry out a device detection operation in accordance with one or more embodiments of the present disclosure. The facility station 300 is an example embodiment of the first processing station 404 shown in FIG. 4. The facility station 300 includes a device detection system 102 capable of determining the number of electronic devices present in an image (e.g., in an image captured by an image capturing device 308 of an interior of a package 304 upon reception in a facility and/or in a station or other area). The depicted facility station 300 is an example of at least a portion of the apparatuses in an entire facility (e.g., a facility for processing electronic devices). The depicted station 300 includes a conveyor 302, a package 304, an imaging device mounting apparatus 306 (e.g., an arm, stand, clamp, or the like), an image capturing device 308, a connection 310 (e.g., in the depicted embodiment, a wired connection), and a device detection computing device 200. In some embodiments, the image capturing device 308 is positioned directly above a conveyor 302 by the mounting apparatus 306. The image capturing device may, in some embodiments, be mounted in any location having a field of view that captures images of the intended electronic devices within the facility. Multiple image capturing devices and/or multiple device detection systems 102 may be used in accordance with various embodiments of the present disclosure. As discussed herein, in some embodiments, multiple overlapping fields of view may be used from different directions to capture images of a plurality of electronic devices from different directions, which multiple directions may be used to generate even further accurate counts.

The station 300 may include an image capturing device 308 configured to capture images of the one or more electronic devices for analysis. In some embodiments, the image capturing device 308 may be part of the device detection computing device 200 and/or may include its own separate computing hardware, such as at least one processor and/or at least one non-transitory memory including computer-coded instructions thereon. The package handling control system (e.g., a separate package handling control system or one integrated into the device detection computing device 200 may be configured to position a package 304 comprising a plurality of electronic devices within a field-of-view of the image capturing device 308. In the depicted embodiment, the device handling control system comprises a conveyor 302, and the package 304 is positioned within the field-of-view of the image capturing device 308 by actuating the conveyor 302 to move the package 304 within the field-of-view of the image capturing device 308. Various other package handling apparatuses may be used, such as robotic arms, manual-assisted systems (e.g., pick-to-light systems), or purely manual systems (e.g., a table beneath the image capturing device onto which an operator loads a package).

In some embodiments, an image of at least an exterior of the package 304 is captured using the image capturing device 308. The first image is transmitted via the connection 310 (e.g., via the input/output circuitry 208 and/or communications circuitry 206) to the device detection computing device 200. In some embodiments, the first image is analyzed to identify a package identifier and the expected electronic device count is determined based on the package identifier. In some embodiments the package identifier is a shipping label disposed on the exterior of the package. In some embodiments, one or more of the at least one image in association with the package identifier is stored. In some embodiments the at least one image in association with the package identifier is stored in datastore 104.

In some embodiments, an expected electronic device count associated with the package is received. In some embodiments, the detected electronic device count and the expected electronic device count are compared. In a first instance where the detected electronic device count and the expected electronic device count are equal, a package handling apparatus 130 such as but not limited to the conveyor 302 is activated to transmit the package 304 to a downstream station, and in a second instance where the detected electronic device count and the expected electronic device count are not equal, an error condition is triggered.

FIG. 4 illustrates a diagram of an exemplary facility 400 environment, such as a facility for processing electronic devices in accordance with various embodiments of the present disclosure. The facility 400 or multiple facilities may include one or more device detection systems 102 having one or more image capturing devices positioned at one or more corresponding locations within the facility 400 or within multiple facilities (e.g., facilities connected via one or more networks). The device detection system(s) 102 may be configured for analyzing images captured of one or more electronic devices, including but not limited to identifying the number of electronic devices associated with the interior of a package or other area of interest. Based on the identification of the number of devices associated with the interior of a package or other area of interest, the device detection system(s) 102 or other components of the facility may be configured to direct one or more downstream processing steps, including but not limited to directing the package and/or the identified number of electronic devices downstream to a subsequent device processing machine.

In an example embodiment, an initial intake process begins at a receiving station 402, where a package is received at the facility 400. At the intake station 402, the package is received at the facility. The intake station 402 may comprise a loading dock or other package holding area. At the time of receipt, a control system associated with the facility (e.g., device detection computing device 200 and/or another computing device associated with the facility) may have stored an inventory of electronic devices that are expected to be received. During the subsequent processing steps, the devices detection system 102 may facilitate matching these expected electronic devices with the actual electronic devices that are received. In some embodiments, no prestored inventory may be available and the facility may identify and process devices as they are received. In either event, the facility 400 must identify and track electronic devices as they proceed through the processing workflow, for example, to facilitate the throughput and accuracy of the facility (e.g., by accurately tracking the processes performed on each electronic device, to allow real time visualization of the location of each electronic device, to correlate the various analyses performed by the facility systems to the correct electronic devices, to control and monitor performance of the facility, and the like). At the receiving station 402, one or more mechanical actuators or user operators may open a package and, if any, remove packaging materials such as bubble wrap, packing peanuts, or the like. In some embodiments, the electronic devices may be left in the package for downstream processing, unpacked and placed unpackaged into the downstream processing machines, moved into a separate facility-based package (e.g., a handling container or crate), or otherwise processed in a packaged or unpackaged state.

At station 404, which may correspond to the station 300 shown in FIG. 3, the one or more electronic devices (e.g., within the package) may be imaged and counted by a device detection system 102 in accordance with various embodiments of the present disclosure. While depicted as a standalone device detection station 404, the device detection operations disclosed herein may be performed in any other location or locations within the facility including at the receiving station 402 and/or downstream station (e.g., labeling, inspection, polishing, etc. stations). The device detection system 102, as shown in FIG. 3, may be positioned over a conveyor 302 carrying packages between two stations. In some embodiments, the conveyors 302 may be configured to stop the electronic device(s) (e.g., the interiors of packages) for imaging, and in some embodiments, the device detection system 102 may be configured to image the electronic device(s) (e.g., the interiors of packages) while they are moving. In various embodiments, the device detection system 102 at station 404 at point A 416A comprises an image capturing device 308 as shown in additional detail in FIG. 3. In an example embodiment, computer-coded instructions, with the at least one processor, cause the system (e.g., a portion of the system responsible for conveyor control) to position a package 304 comprising a plurality of electronic devices within a field-of-view of an image capturing device 308.

In some embodiments, for example, at either the receiving station 402 or device detection station 404, the system (e.g., device detection system 102 or another portion of the facility system) may capture an image or otherwise scan an exterior of the package to detect a package identifier associated with the package. For example, in some embodiments, a code scanner (e.g., a bar code reader, including QR code readers, one dimensional bar code readers, etc.) may be configured to read a decodable indicia on an exterior of the package. In some embodiments, an image of at least an exterior of the package 304 is captured using the image capturing device 308 and a code or other identifiable indicia may be read from the exterior of the package (e.g., via decoding and/or optical character recognition of plain text). The image/scan or a decode data object associated with the image/scan may be transmitted to and/or analyzed by a computing device (e.g., the device detection computing device 200 shown in FIGS. 1-3) to determine an expected device count associated with the package. In some embodiments the package identifier is a shipping label disposed on the exterior of the package. In some embodiments, one or more of the at least one image in association with the package identifier is stored, for example, in datastore 104 shown in FIG. 1. In some embodiments, at least a portion of the plurality of images are captured before positioning the package within the field-of-view of the image capturing device 308 and at least a second portion of the plurality of images are captured after transmitting the package to the downstream station, such as, but not limited to, one or more primary analysis stations 408.

The expected device count may be determined via one or more means, each of which is contemplated to be usable with the various embodiments disclosed herein. In some embodiments, the expected device count may be determined via directly extracting the expected device count from the package or other physically available media. For example, the device detection system 102 may image at least a portion of the exterior of the package or other media and may extract the expected device count from the extracted data. In some embodiments, for example, the expected device count may be captured in human-readable form by the image capturing device (e.g., a listing of contents or a quantity of devices in the package written on a shipping label or other media). The image captured by an image capturing device may be analyzed (e.g., via optical character recognition, natural language processing, computer vision model, and/or the like) to extract the expected device count. For example, the device detection computing device or another processing device of the system may read a list of contents, programmatically identify each separate electronic device on the list (e.g., via classifier or another model based analysis of the text and/or image data), and count the total number of electronic devices in the list to generate the expected device count. As another example, the number of electronic devices may be printed on the packaging or other media (e.g., “3 Mobile Phones”), and the device detection computing device or another processing device of the system may analyze the image or text extracted from the image to extract the expected count of “three” devices (e.g., via optical character recognition, natural language processing, computer vision model, or the like). In some embodiments, the expected device count may be encoded directly on the package or other media (e.g., a QR code containing the expected device count that may be printed on a shipping label and read by a code scanner, such as an image capturing device and corresponding computer-executed analysis software).

In some embodiments, the expected device count may be stored in a repository (e.g., datastore 104 in FIG. 1) during or following an initial, remote transaction between the packager of the electronic devices and the facility or an associated computing system (e.g., a shipping log generated by a third party shipping company). In some embodiments, a package identifier may be read from the exterior of the package or other media using the foregoing direct capture processes, and the package identifier may be used to retrieve the stored expected device count.

In some further embodiments, using any of the foregoing processes for detecting an expected device count, the expected device count may apply to a plurality of packages, such as a plurality of packages from a common source. In such embodiments, the device detection system may combine the analyses of multiple packages when comparing with the expected device count and/or may flexibly analyze each individual package as part of a larger group. For example, a stored record may indicate “three packages, forty-two devices total”, such that detected device counts from all three packages are combined to compare with the cumulative expected device count. In some such embodiments, each individual package of the three may have an unknown, variable number of electronic devices or a separate expected device count.

In some other embodiments, the system may not have any expected device count or may not be able to extract an expected device count for one or more packages. In some embodiments, the system may identify each device individually (e.g., via visual analysis, such as reading a Serial No. or IMEI from the device screen or back and/or via electronic analysis, such as by communicating programmatically with the electronic device over USB or wireless connection). In any of the foregoing embodiments, the system may create placeholder profiles for each electronic device until the identity of the electronic devices can be verified or populated with captured data (e.g., by a downstream station). The profiles may be linked to the package, the shipper, a user account, or any other connected processes or systems.

In embodiments in which an image capturing device of a device detection system is positioned downstream of another image capturing device in the facility processing flow (e.g., at points 416B, 416C, and/or 416D shown in FIG. 4), the expected device count may comprise a detected device count captured and analyzed from the upstream images captured by the upstream image capturing device (e.g., at point 416A or another point upstream of a further downstream point) and the downstream image capturing device may be used to ensure continuity of the device processing flow (e.g., to track the flow of devices through the facility, ensure that devices are not lost or misdirected, and to trigger various downstream processing steps by one or more device processing machines).

Moreover, in some embodiments, the expected device count may be modified in instances in which the electronic device processing flow includes unpacking and processing the electronic devices individually, such that the system can monitor the device flows through the system under any conditions. For example, the package may be unpacked and the electronic devices loaded into the analysis station(s) 408 for individual processing. The downstream image capturing devices (if any) may thereby capture images of the individual electronic devices outside their original package (e.g., either as individual devices or as new groups of devices). In such embodiments, the system (e.g., device detection system 102 or another portion of the control systems of the facility) may increment or recalculate the expected device count based on the intended flow of devices (e.g., incrementing a counter until each of the devices in the original package are detected, combining the detected device counts from multiple image capturing devices when processing along parallel work streams, etc.).

The expected device count may be used in conjunction with the images captured by at least one image capturing device to validate the contents of the package or otherwise confirm the accuracy of an expected group of electronic devices. In some embodiments, the device detection system 102 at station 404 captures at least one image of at least an interior of the package using the image capturing device 308. In some embodiments, and device detection system 404 applies the image(s) to one or more device detection models 106, which models may output analysis associated with electronic devices captured in the image(s) or a portion thereof. For example, the device detection model 106 may be configured to output a detected electronic device count associated with the interior of the package.

During operation, in some embodiments, one or more packages may be received at the receiving station 402 and at the receiving station or downstream therefrom, the device detection system 102 may image at least the interior of the package to verify the contents thereof. For example, the device detection system 102 may be positioned at an imaging station 404 after the packages are received. The device detection system 102 or a processing system (e.g., a control system) associated therewith may receive an expected electronic device count associated with the package using any of the techniques described herein. In some embodiments, the device detection system 102 or the processing system (e.g., a control system) associated therewith compares the detected electronic device count and the expected electronic device count. This comparison may validate the expected contents of the package and may facilitate various downstream functions.

In a first instance where the detected electronic device count and the expected electronic device count are equal, a package handling apparatus (e.g., conveyor 302 shown in FIG. 3) may be activated to transmit the package to a downstream station (e.g., to the labeling station 408A of the primary analysis line 408 in the depicted embodiment). In a second instance where the detected electronic device count and the expected electronic device count are not equal, an error condition is triggered. In some embodiments, the error condition may cause the package and/or one or more of the electronic devices to be diverted to another error handling station 406. In some embodiments, the error condition may signal a manual or automatic removal of the package and/or one or more other remedial steps. In some embodiments, the error condition may further trigger programmatic remedial measures, including but not limited to determining the actual electronic device count in the package (e.g., via a second image capturing device, a manual user input, or the like) and updating a training of the device detection model and/or replacing or adjusting the initial image capturing device based on the actual electronic device count and the captured image. In some embodiments, multiple image capturing devices may be used to independently image the package to improve the robustness of the count.

The device detection model may comprise one or more object classification models configured to classify predetermined object types in an image (e.g., a computer vision task). In some embodiments, the device detection model may be a real-time object detection model configured to rapidly detect and classify objects in an image in real time as one or more images are captured (e.g., at least as fast as a framerate of a video camera, such as greater than 10 Hz).

For example, in some embodiments, the device detection model may include a convolutional neural network trained using labeled training data to identify electronic devices within images. In some embodiments, the at least one convolutional neural network comprises at least 24 convolutional layers. In some embodiments, the at least one convolutional neural network comprises at least 50 convolutional layers. In some embodiments, the at least one convolutional neural network comprises at least 53 convolutional layers. The device detection model may include a plurality of convolutional and non-convolutional layers. For example, the device detection model may include connected layers comprising convolutional and non-convolutional (e.g., linear layers), for example, at least 24 or at least 50 convolutional layers (e.g., 53 convolutional layers) and total of at least 200 (e.g., 225 or more layers).

In some embodiments, the device detection model may use a convolutional neural network as part of a real-time, single stage object detector. A single stage object detector may be configured to predict bounding boxes and class probabilities for one or more electronic devices in a captured image with a single pass to facilitate rapid analysis of the images, such that classification can be performed on the fly without hindering the various processes and moving components of the facility device processing machines. For example, in embodiments in which the package is movable (e.g., via conveyor 302 shown in FIG. 3), the package may continue moving while the images are captured and/or may be momentarily stopped for image capture. In some embodiments, the device detection model (e.g., the single stage object detector) may be configured to divide each analyzed image into a grid of cells. Via the layers of the CNN, the model may then determine a probability score associated with the presence of an electronic device for each cell. The model may further determine the bounding box coordinates of each detected electronic device and classifies the object (e.g., electronic device) within each bounding box. In some embodiments, the bounding boxes and probabilities for each cell may be post-processed to remove overlapping boxes and choose a boxes with the highest probability. The device detection model may filter the set of bounding boxes by removing at least one lower probability bounding box overlapping at least one higher probability bounding box to generate a set of predicted bounding boxes with class labels for each electronic device in the one or more of the at least one image. In some embodiments, each image may be pre-processed, such as to mask portions of the image not corresponding to the interior of the package.

One or more device detection models may be trained for different classification tasks or trained to optimize different performance characteristics. For example, separate models may be trained for each image capturing device and/or each station. In some embodiments, a device detection model may be configured to classify different complexities of electronic device problems. For example, a device detection model may be configured to classify electronic devices in various positions, and in some instances, overlapping electronic devices (e.g., devices piled atop each other). In some embodiments, multiple models may be trained for specific image capturing devices, specific fields of view, or the like such that each image capturing device has a separate model associated with its perspective. In some embodiments, a single model may be used for multiple image capturing devices, multiple fields of view, or the like. The classification may be generic to all electronic devices (e.g., electronic device vs. not electronic device) or more granular (e.g., object type such as phone vs tablet, make or model such as IPHONE vs. non-IPHONE, etc.). In some embodiments, the device detection model 106 is configured to identify a particular make or model of electronic device, the particular make or model of electronic device corresponding to a make or model of one or more of an imaged plurality of electronic devices.

In some embodiments, a plurality of images may be captured during an imaging operation, and each or a subset of the plurality of images may be applied to the device detection model. The device detection model may output at least a detected device count for each image analyzed. In some embodiments, the device detection system may collect multiple counts associated with each package and compare or combine the outputs (e.g., averaging the outputs for a plurality of images of the package).

In some embodiments, the plurality of images are applied sequentially to the device detection model 106, such that the device detection model 106 outputs a sequence of detected electronic device counts associated with the interior of the package. In some embodiments, the at least one image comprises a plurality of images (e.g., multiple images, a burst of images, a continuous stream of images—such as a video, or the like). In some embodiments, applying the at least one image to the device detection model 106 comprises applying the plurality of images to the device detection model 106.

In some embodiments, a first electronic device of the first plurality of electronic devices is overlapping a second electronic device of the plurality of electronic devices. The detected electronic device count comprises counts representing both the first electronic device and the second electronic device, for example in an instance in which the device detection model is trained to detect overlapping (e.g., occluded) electronic devices and/or in an instance in which image capturing devices from multiple overlapping fields of view (e.g., image capturing devices pointed at the same location from different directions) are used to detect devices obscuring each other.

In some embodiments, the device detection system programmatically generates a plurality of device profile data objects associated with the first plurality of one or more electronic devices detected in the detected electronic device count. In some embodiments, the device detection system 102 at station 408A prints a device ID label for each of the first plurality of one or more electronic devices. In some embodiments, the individual electronic devices identified by the device detection model may be assigned specific device ID labels, which devices and labels may be tracked throughout the facility. In some embodiments, images of each electronic device may be stored to track the appearance of the electronic device through the facility (e.g., to identify the source of accidental damage and/or retain visual examples of the changes to the electronic device through the device processing machines of the processing stations). In some embodiments, the stored images may be used for cosmetic grading and other further image analyses by the device detection system or another associated processing device.

In some embodiments, the device detection system 102 at station 404 at point A 416A comprises a second image capturing device in addition to the original, first image capturing device. In some embodiments, the second image capturing device acts as a redundancy and checking mechanism, imaging the same package to corroborate and compare the counts of the device detection model outputs for the images from each image capturing device. As a non-limiting example, in some embodiments, the imaging station 404 positions a package 308 comprising a first plurality of one or more electronic devices within the field-of-view of the second image capturing device. In some embodiments, the device detection system 102 at station 404 captures at least one second image of at least the interior of the package 308 using the second image capturing device. In some embodiments, the device detection system 102 applies one or more of the at least one second image to the device detection model 106, the device detection model 106 is configured to output a second detected electronic device count associated with the interior of the package 308. In some embodiments, the device detection system 102 receives a second expected electronic device count associated with the package 308. In some embodiments, the device detection system 102 compares the second detected electronic device count and the second expected electronic device count. In the first instance where the second detected electronic device count and the second expected electronic device count are equal, the device detection system 102 activates the package handling apparatus (e.g., conveyor 302 shown in FIG. 3) to transmit the package to the downstream station. In the second instance where the second detected electronic device count and the second expected electronic device count are not equal, the device detection system triggers the error condition. In some further embodiments, if both the detected device count generated by analyzing the first image of the first image capturing device and the detected device count generated by analyzing the second image of the second image capturing device do not both return the expected device count, an error condition may be triggered (e.g., requiring matching, correct outputs from both models and image capturing device images). In some embodiments, if either one of the detected device count generated by analyzing the first image of the first image capturing device or the detected device count generated by analyzing the second image of the second image capturing device returns the expected device count the system may proceed normally (e.g., either model matching the expected count may be sufficient). A similar process and analysis steps may be performed with respect to sequentially captured images, whether captured by the same image capturing device or a different image capturing device.

The device detection system at point A can be modified to be placed at points B 416B, point C 416C and point D 416D and/or additional image capturing devices (using the same device detection computing device), or entire device detection systems (for multiple systems) may be positioned at the respective points B 416B, point C 416C and point D 416D. With respect to each of these points, the device detection system 404 can be duplicated and placed at each of the points, multiple image capturing devices can be part of the same device detection system, and/or the device detection system 404 can be moved from place to place to serve the same purpose of detecting the number of electronic devices present at each station. In some embodiments, one or more image capturing devices with fields of view covering multiple stations up to and including the entire facility may be used to count or further analyze electronic devices in multiple areas simultaneously. In some embodiments, an entire operational flow path of the electronic devices may be within a field of view of at least one image capturing device for detection of electronic devices throughout the entire operational flow path or any subdivision thereof, including between any two stations indicated in FIG. 4.

By way of non-limiting example, in some embodiments, the device detection system 102 further comprises an additional image capturing device. In some embodiments, the device detection system 102 positions a package 308 comprising a plurality of one or more electronic devices within the field-of-view of the second image capturing device at a station downstream of a first image capturing device. In some embodiments, the device detection system 102, captures at least one second image of at least the interior of the package using the second image capturing device or at least one second image of the plurality of electronic devices inside or removed from the package. In some embodiments, the device detection system 102, applies one or more of the at least one second image to the device detection model 106, the device detection model 106 is configured to output a second detected electronic device count associated with the interior of the package 304. In some embodiments, the device detection system 102, receives a second expected electronic device count associated with the package and compares the second detected electronic device count and the second expected electronic device count. In the first instance where the second detected electronic device count and the second expected electronic device count are equal, the device detection system 102, activates the package handling apparatus 130 such as, but not limited to, the convey 302, to transmit the package to the downstream station, such as, but not limited to, the Visual Inspection and Grading Station 408B, from the Label station 408A in an instance in which the second image capturing device was placed at Point B 416B. In the second instance where the second detected electronic device count and the second expected electronic device count are not equal, the device detection system 102 triggers the error condition. The second expected device count may be defined by the detected device count determined from an image captured by the first image capturing device upstream of the second image capturing device.

In some embodiments, the image capturing device 308 and the second image capturing device have overlapping fields-of-view. In some embodiments, the positioning of the package 304 within the field-of-view of the image capturing device 308 comprises positioning the package at a first location. In some embodiments, a second location is defined downstream of the first location at the downstream station or between the first location and the downstream station. In some embodiments, the device detection system generates a plurality of images of the package while the package is between the first location and the second location.

In some embodiments, the device detection system 102 comprising a second image capturing device, captures at least one second image of at least the interior of the package using the second image capturing device while the package is within the field-of-view of the image capturing device 308 and a field-of-view of the second image capturing device 308. In some embodiments, the device detection system 102 applies one or more of the at least one second image to the device detection model 106. The device detection model 106 may output a second detected electronic device count associated with the interior of the package and compares the second detected electronic device count and the first detected electronic device count.

In an example embodiment, the device detection system 102 further comprises a second image capturing device defining a second field-of-view. The first image capturing device 308 is disposed at a first location (e.g., 416A-416C) and the second image capturing device 308 is disposed at a second location (e.g., 416B-416D). The field-of-view of the first image capturing device may include a first station, and the second field-of-view of the second image capturing device may include the downstream station, which further causes the device detection system to capture at least one second image of at least the interior of the package using the second image capturing device. In some embodiments, the device detection system 102 applies one or more of the at least one second image to the device detection model 106. The device detection model 106 may be configured to output a second detected electronic device count associated with the interior of the package. In some embodiments, the device detection system 102 compares the second detected electronic device count and the detected electronic device count to verify a same number of electronic devices in the interior of the package.

In some embodiments, the device detection system 102 further comprises a second image capturing device defining a second field-of-view. The image capturing device 308 is disposed at a first location (e.g., 416B-416D) and the second image capturing device 308 is disposed at a second location (e.g., 416A-416C) upstream of the first location. The field-of-view of the first image capturing device may include a first station, and the second field-of-view of the second image capturing device may include an upstream station, which further causes the device detection system 102 to capture at least one second image of at least the interior of the package using the second image capturing device. In some embodiments, the device detection system applies one or more of the at least one second image to the device detection model. The device detection model may output a second detected electronic device count associated with the interior of the package and may store the second detected electronic device count as the expected electronic device count.

In addition to or instead of the device detection system 102 being placed at and/or between the label station 408A and the visual inspection and grading station 408B of the one or more primary analysis stations 408 as shown in FIG. 4, the device detection system or a second device detection system can have image capturing devices also placed at and/or between the visual inspection and grading station 408B and the electronic inspection diagnostic station 408C. This is represented by point C 416C. Example visual inspection and grading stations are shown and described in U.S. Pat. No. 11,580,627 entitled “Systems and Methods for Automatically Grading Pre-Owned Electronic Devices”, filed Jan. 5, 2021, which application is incorporated by reference herein in its entirety. Example electronic inspection stations are shown and described in U.S. Provisional Application No. 63/615,068 entitled “Robot Enabled Mobile Device Manipulation System, Method, and Apparatus”, filed Dec. 27, 2023, which application is incorporated by reference herein in its entirety.

In addition to or instead of the device detection system 102 being placed at and/or between the visual inspection and grading station 408B and the electronic inspection diagnostic station 408C, the device detection system 404 can be placed at an intervention station 410 (e.g., an inspection location following the primary analysis and prior to further downstream interactions, such as device polishing 412, repair/refurbishment 414, regrading 414, and/or other storage, disposition, analysis, and/or modification stations. For example, the intervention station 410 consists of three possible outcomes of the electronic inspection and diagnostic station 408C. These comprise grade A, grade B, and grade C. The grade of the electronic devices is determined by the visual inspection and grading station 408B (e.g., exterior analysis of the devices) and/or by the electronic inspection diagnostic station 408C (e.g., electronic analysis of the devices, such as software and hardware diagnostics). The grade may be transmitted to a control system (e.g., device detection system 102 or an associated computing system) to transmit the electronic device(s) through the intervention station 410 to the polishing station 412 and/or the repair/refurbishment and/or regrading station 414 depending upon the grade of the electronic device and/or other details. The example placement of the device detection system at and/or between the invention station 410, the polishing station 412, and the reconstruction and regrading station 414 is represented by point D 416D. Example phone polishing, repair, grading, and inspection stations are shown and described in U.S. Publication No. 2024/0377806 entitled “Methods, Systems, and Apparatuses for User Device Repair and Conditioning”, filed May 10, 2023, which application is incorporated by reference herein in its entirety.

Following analysis of the electronic devices (e.g., via the analysis line 408 processing machines) and any subsequent preparation of the electronic devices (e.g., via polishing 412, repair/refurbish and/or regrading 414 device processing machines), the electronic devices may optionally be sent to a storage station 418 before being selected 420 and transmitted (e.g., via shipping station 422) out of the facility. The various selection 420 processes in some embodiments may be based on the grades. As with the preceding stations, one or more image capturing devices may be positioned in, adjacent, or between the stations of the facility to generate detected device counts and perform any other analyses associated with the electronic devices. With each imaging process, the grouping of electronic devices may be processed by the device detection system 102 to determine if the number of electronic devices has increased or decreased relative to the initial number of electronic devices received by the facility (e.g., at the imaging station 404). As discussed herein, in some embodiments, the electronic devices are removed from the package during processing (e.g., after, before, or during the imaging station 404) after which the electronic devices may be tracked individually using an ongoing, incremented device count via the same device detection processes described herein. During storage 418, electronic devices may be placed into new packages (e.g., sorted by grade, stage in the preparation process, make and/or model, or the like), and the device detection system(s) 102 may be configured to count the electronic devices in the new packages and compare them with a new expected device count (e.g., an internally stored count of the devices in each new package).

The system may track the location of the devices seamlessly between each stage of the process. The device detection system(s) described herein may provide continuity and omnipresence to a facility where previously only direct interaction with the devices (e.g., often manual review) could identify the location of a particular device, and these direct interactions may be sporadic (e.g., at a particular station) such that the system only receives brief snapshots of the locations of each device (e.g., when scanned in at a station). The system may correlate those snapshots with the vision data and counts of the present disclosure to identify devices in an imager's field of view and track those devices through the facility in real time and with perfect or near perfect continuity without requiring, although not precluding, image capturing devices directly read information from the electronic devices at all times.

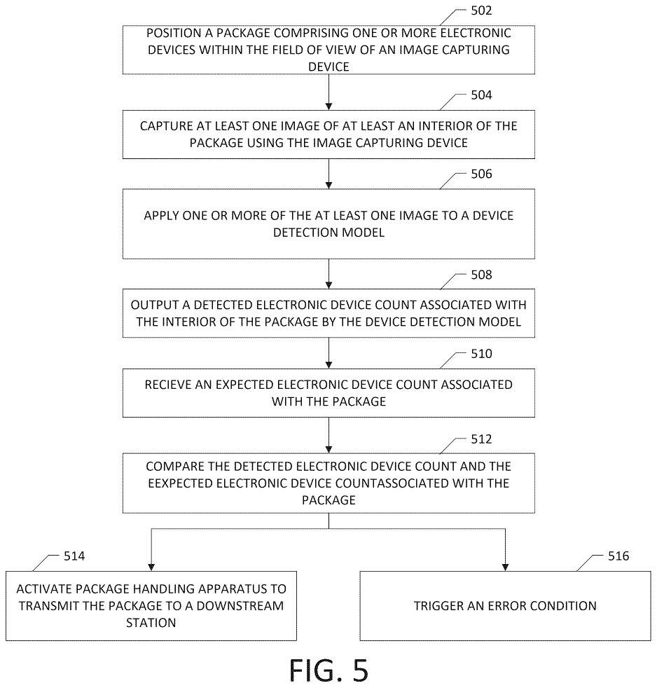

FIG. 5 illustrates a flowchart representing an example process for detecting at least one electronic device associated with the interior of a package via a device detection system 102 in accordance with one or more embodiments of the present disclosure. In some embodiments, the process is embodied by computer program code stored on a non-transitory computer-readable storage medium of a computer program product configured for execution by the respective apparatuses described herein to perform the process as depicted and described. Additionally, or alternatively, in some embodiments, the process is performed by one or more specifically configured computing devices such as the device detection computing device 200 alone or in communication with one or more other component(s), device(s), and/or system(s) (e.g., other portions of the device detection system 102 and/or multiple device detection systems, device detection computing devices, and/or other processing components of the facility). In this regard, in some such embodiments, the device detection computing device 200 is specially configured by computer-coded instructions (e.g., computer program instructions) stored thereon, for example in the memory 204 and/or another component depicted and/or descried herein and/or otherwise accessible to the device detection computing device 200, for performing the operations as depicted and described. In some embodiments, the device detection computing device 200 is embodied by, or in communication with, on or more external apparatus(es), system(s), device(s), and/or the like to perform one or more of the operations as depicted and described. For example, the device detection computing device 200 can be in communication with the image capturing devices, the datastore 104, and/or the network 110 integrated with the device detection system 102. For purposes of simplifying the description and with limitation, the process described in FIG. 5 is described as performed by and from the perspective of the facility (e.g., facility 400 shown in FIG. 3) including by a device detection system 102 comprising a device detection computing device 200 and various connected components (e.g., image capturing device, conveyor, etc.) as would be understood for the recited functions.

The process begins at operation 502 in the example embodiment. At operation 502, the device detection system 102 or another component (e.g., computing device) of the facility system may include means, such as the processor 202, memory 204, communications circuitry 206, input/output circuitry 208, display 210, data storage circuitry 212, device detection model circuitry, and package handling system circuitry, or any combination thereof, that positions a package comprising one or more electronic devices within the field of view of an image capturing device. The package handling system circuitry may be part of a separate apparatus from the image capturing device and associated processing circuitry or both circuitries may be part of the same apparatus. For example, in some embodiments, the conveyor (e.g., conveyor 302 shown in FIG. 3) may transport the package into the field of view of at least one image capturing device (e.g., image capturing device 308 shown in FIG. 3). In some embodiments, the package may be opened prior to moving it with the conveyor, and in some embodiments, an actuator or other mechanical manipulator may be used to open the package. In some embodiments, the package handling apparatus 103 associated with the conveyor 302 may be configured to manipulate the package within the field of view of a second image capturing device. In some embodiments, the image capturing device 308 and the second image capturing device have overlapping fields of view. In some embodiments, the package handling apparatus 130 associated with the conveyor 302 may be configured transmit the package 304 to transmit the package to the downstream station.

At operation 504, the device detection system 102 or another component (e.g., computing device) of the facility system includes means, such as the processor 202, memory 204, communications circuitry 206, input/output circuitry 208, display 210, data storage circuitry 212, device detection model circuitry 214, and package handling circuitry 216, or any combination thereof, to capture at least one image of at least an interior of the package using the image capturing device. The device detection system 102 may trigger the image capturing device to capture the image(s) for electronic device analysis. In some embodiments, the image capturing device is triggered automatically and/or continually capturing images (e.g., at a set interval or framerate). In some embodiments, a package opening step may occur prior to capturing the image.

At operation 506, the device detection system 102 or another component (e.g., computing device) of the facility system includes means, such as the processor 202, memory 204, communications circuitry 206, input/output circuitry 208, display 210, data storage circuitry 212, device detection model circuitry 214, and package handling circuitry 216, or any combination thereof, to apply the at least one image to a device detection model 106. As described herein, in some embodiments, the device detection system 102 can detect the number of electronic devices associated with the package 304 and/or conduct other analyses on the package. For example, the device detection system 102 may employ a device detection model 106 to determine the one or more electronic devices associated with a package 304.

In some embodiments, the device detection model 106 enables the device detection computing device 200 to interpret and understand the visual information associated with a plurality of images captured via the image capturing devices. The device detection model 106 includes object detection in accordance with the various embodiments discussed herein. For example, in some embodiments, the device detection model 106 may be configured to detect instances of semantic objects of the predefined class such as electronic devices. The device detection model 106 divides the first image of a plurality of images into a grid of cells. In some embodiments, the device detection model 106 may predict the probability of a presence of an object, such as the sematic objects of a predefined class such as electronic devices, and the bounding box coordinates of the object. In some embodiments, the device detection model 106 outputs a set of predicted bounding boxes and the respective labels for the sematic objects of the predefined class such as electronic devices for each object in the image.

In some embodiments, the device detection model 106 programmatically generates a plurality of device profile data objects associated with the first plurality of one or more electronic devices detected in the detected electronic device count and printing a device ID label for each of the first plurality of one or more electronic devices. In some embodiments, the device detection model 106 further comprises masking the one or more of the at least one image to isolate the interior of the package before applying the one or more of the at least one image to a device detection model. In some embodiments, the device detection model 106 comprises at least one convolutional neural network.

At operation 508, the device detection system 102 or another component (e.g., computing device) of the facility system includes means, such as the processor 202, memory 204, communications circuitry 206, input/output circuitry 208, display 210, data storage circuitry 212, device detection model circuitry 214, and package handling circuitry 216, or any combination thereof, for outputting a detected electronic device count associated with the interior of the package 304. The output may be via signal sent from the device detection computing system to a user interface or other internal or separately executed computer program for processing and analysis of the count.

At operation 510, the device detection system 102 or another component (e.g., computing device) of the facility system includes means, such as the processor 202, memory 204, communications circuitry 206, input/output circuitry 208, display 210, data storage circuitry 212, device detection model circuitry 214, and package handling circuitry 216, or any combination thereof, for receiving the expected electronic device count. In some embodiments, the analysis of the count is performed entirely within one apparatus, and in some embodiments, operations 508 and 510 may occur between two software processes running within the same machine or may be omitted.

At operation 512, the device detection system 102 or another component (e.g., computing device) of the facility system includes means, such as the processor 202, memory 204, communications circuitry 206, input/output circuitry 208, display 210, data storage circuitry 212, device detection model circuitry 214, and package handling circuitry 216, or any combination thereof, for comparing the detected electronic device count and the expected electronic device count associated with the package. If the detected electronic device count and the expected electronic device count match or the result of the comparison is otherwise successful, the process may proceed to operation 514. If the detected electronic device count and the expected electronic device count do not match or the result of the comparison is otherwise unsuccessful, the process may proceed to operation 516.

At operation 514, the device detection system 102 or another component (e.g., computing device) of the facility system includes means, such as the processor 202, memory 204, communications circuitry 206, input/output circuitry 208, display 210, data storage circuitry 212, device detection model circuitry 214, and package handling circuitry 216, or any combination thereof, to activate the package handling apparatus (e.g., conveyor 302) to transmit the package to a downstream station.

At operation 516, the device detection system 102 or another component (e.g., computing device) of the facility system includes means, such as the processor 202, memory 204, communications circuitry 206, input/output circuitry 208, display 210, data storage circuitry 212, device detection model circuitry 214, and package handling circuitry 216, or any combination thereof, where an error condition is triggered by the difference in the detected electronic device count and the expected electronic device count.

### EXAMPLE EMBODIMENTS

Non-limiting example embodiments of the present disclosure will now be described:

Embodiment 1. A computer-implemented method for determining a number of electronic devices, wherein the computer-implemented method comprises: positioning a package comprising a first plurality of electronic devices within a field-of-view of a first image capturing device; capturing at least one image of at least an interior of the package using the first image capturing device; applying one or more of the at least one image to a device detection model, the device detection model is configured to output a detected electronic device count associated with the interior of the package; receiving an expected electronic device count associated with the package; comparing the detected electronic device count and the expected electronic device count; in a first instance where the detected electronic device count and the expected electronic device count are equal, activate a package handling apparatus to transmit the package to a downstream station; and in a second instance where the detected electronic device count and the expected electronic device count are not equal, trigger an error condition.

Embodiment 2. The computer-implemented method of Embodiment 1, further comprising:
capturing a first image of at least an exterior of the package; analyzing the first image to identify a package identifier; and determining the expected electronic device count based on the package identifier.

Embodiment 3. The computer-implemented method of Embodiment 2, wherein the package identifier is a shipping label disposed on the exterior of the package.

Embodiment 4. The computer-implemented method of any one of Embodiments 1-3, wherein the device detection model is trained to identify a particular make or model of electronic device, the particular make or model of electronic device corresponding to a make or model of the first plurality of electronic devices.

Embodiment 5. The computer-implemented method of any one of Embodiments 2 or 3, further comprising storing one or more of the at least one image in association with the package identifier.

Embodiment 6. The computer-implemented method of any one of Embodiments 1-5, further comprising capturing a plurality of images including the at least one image, via the first image capturing device, wherein at least a portion of the plurality of images are captured before positioning the package within the field-of-view of the first image capturing device and at least a second portion of the plurality of images are captured after transmitting the package to the downstream station.

Embodiment 7. The computer-implemented method of Embodiment 6, wherein the plurality of images are applied sequentially to the device detection model, such that the device detection model outputs a sequence of detected electronic device counts associated with the interior of the package.

Embodiment 8. The computer-implemented method of any one of Embodiments 1-7, wherein the at least one image comprises a plurality of images, and wherein applying the at least one image to the device detection model comprises applying the plurality of images to the device detection model.

Embodiment 9. The computer-implemented method of any one of Embodiments 1-8, further comprising a second image capturing device, wherein the computer-implemented method further comprises: positioning the package comprising the first plurality of electronic devices within the field-of-view of the second image capturing device; capturing at least one second image of at least the interior of the package using the second image capturing device; applying one or more of the at least one second image to the device detection model, the device detection model is configured to output a second detected electronic device count associated with the interior of the package; receiving a second expected electronic device count associated with the package; comparing the second detected electronic device count and the second expected electronic device count; in the first instance where the second detected electronic device count and the second expected electronic device count are equal, activate the package handling apparatus to transmit the package to the downstream station; and in the second instance where the second detected electronic device count and the second expected electronic device count are not equal, trigger the error condition.

Embodiment 10. The computer-implemented method of any one of Embodiments 1-9, wherein positioning the package within the field-of-view of the first image capturing device comprises positioning the package at a first location, wherein a second location is defined downstream of the first location at the downstream station or between the first location and the downstream station, wherein the computer-implemented method further comprises: generating a plurality of images of the package while the package is between the first location and the second location via the first image capturing device or a second image capturing device; and applying one or more of the plurality of images to the device detection model to generate one or more additional detected electronic device counts.

Embodiment 11. The computer-implemented method of any one of Embodiments 1-10, wherein the first image capturing device is positioned above a conveyor, and wherein positioning the package within the field-of-view of the first image capturing device comprises actuating the conveyor to move the package within the field-of-view of the first image capturing device.

Embodiment 12. The computer-implemented method of any one of Embodiments 1-11, further comprising programmatically generating a plurality of device profile data objects associated with the first plurality of electronic devices detected in the detected electronic device count and printing a device ID label for each of the first plurality of electronic devices.

Embodiment 13. The computer-implemented method of any one of Embodiments 1-12, further comprising masking the one or more of the at least one image to isolate the interior of the package before applying the one or more of the at least one image to the device detection model.

Embodiment 14. The computer-implemented method of any one of Embodiments 1-13, wherein the device detection model comprises at least one convolutional neural network.

Embodiment 15. The computer-implemented method of Embodiment 14, wherein the at least one convolutional neural network comprises at least 24 convolutional layers.

Embodiment 16. The computer-implemented method of Embodiments 14 or 15, wherein applying one or more of the at least one image to the device detection model comprises passing the one or more of the at least one image through the at least one convolutional neural network to divide one or more of the at least one image into a grid of cells and generating a set of bounding boxes and class probabilities for each cell of the grid of cells.

Embodiment 17. The computer-implemented method of Embodiment 16, wherein applying one or more of the at least one image to the device detection model further comprises filtering the set of bounding boxes by removing at least one lower probability bounding box overlapping at least one higher probability bounding box to generate a set of predicted bounding boxes with class labels for each electronic device in the one or more of the at least one image.

Embodiment 18. The computer-implemented method of any one of Embodiments 1-17, wherein a first electronic device of the first plurality of electronic devices is overlapping a second electronic device of the first plurality of electronic devices, and wherein the detected electronic device count comprises counts representing both the first electronic device and the second electronic device.

Embodiment 19. The computer-implemented method of any one of Embodiments 1-18, wherein in the second instance, the method further comprises determining an actual electronic device count and updating a training of the device detection model based on the actual electronic device count and the one or more of the at least one image.

Embodiment 20. The computer-implemented method of any one of Embodiments 1-19, further comprising a second image capturing device, wherein the computer-implemented method further comprises: capturing at least one second image of at least the interior of the package using the second image capturing device while the package is within the field-of-view of the first image capturing device and a field-of-view of the second image capturing device; applying one or more of the at least one second image to the device detection model, wherein the device detection model outputs a second detected electronic device count associated with the interior of the package; and comparing the second detected electronic device count and the detected electronic device count.

Embodiment 21. The computer-implemented method of any one of Embodiments 1-20, further comprising a second image capturing device defining a second field-of-view, wherein the first image capturing device is disposed at a first location and the second image capturing device is disposed at a second location, wherein the field-of-view includes a first station, and wherein the second field-of-view includes the downstream station, the method further comprising: capturing at least one second image of at least the interior of the package using the second image capturing device; applying one or more of the at least one second image to the device detection model, the device detection model is configured to output a second detected electronic device count associated with the interior of the package; and comparing the second detected electronic device count and the detected electronic device count to verify a same number of electronic devices in the interior of the package.

Embodiment 22. The computer-implemented method of any one of Embodiments 1-21, further comprising a second image capturing device defining a second field-of-view, wherein the first image capturing device is disposed at a first location and the second image capturing device is disposed at a second location upstream of the first location, wherein the field-of-view includes a first station, and wherein the second field-of-view includes an upstream station, the method further comprising: capturing at least one second image of at least the interior of the package using the second image capturing device; applying one or more of the at least one second image to the device detection model, wherein the device detection model outputs a second detected electronic device count associated with the interior of the package; and storing the second detected electronic device count as the expected electronic device count.

Embodiment 23. A system comprising at least one processor, and at least one non-transitory memory including computer-coded instructions thereon; the computer-coded instructions, with the at least one processor, cause the system to: position a package comprising a first plurality of electronic devices within a field-of-view of a first image capturing device; capture at least one image of at least an interior of the package using the first image capturing device; apply one or more of the at least one image to a device detection model, the device detection model is configured to output a detected electronic device count associated with the interior of the package; receive an expected electronic device count associated with the package; compare the detected electronic device count and the expected electronic device count; in a first instance where the detected electronic device count and the expected electronic device count are equal, activate a package handling apparatus to transmit the package to a downstream station; and in a second instance where the detected electronic device count and the expected electronic device count are not equal, trigger an error condition.

Embodiment 24. The system of Embodiment 23, further comprising: capturing a first image of at least an exterior of the package; analyzing the first image to identify a package identifier; and determining the expected electronic device count based on the package identifier.

Embodiment 25. The system of Embodiment 24, wherein the package identifier is a shipping label disposed on the exterior of the package.

Embodiment 26. The system of Embodiment 24 or 25, wherein the device detection model is trained to identify a particular make or model of electronic device, the particular make or model of electronic device corresponding to a make or model of the first plurality of electronic devices.

Embodiment 27. The system of any one of Embodiments 24-26, further comprising storing one or more of the at least one image in association with the package identifier.

Embodiment 28. The system of any one of Embodiments 23-27, further comprising capturing a plurality of images including the at least one image, via the first image capturing device, wherein at least a portion of the plurality of images are captured before positioning the package within the field-of-view of the first image capturing device and at least a second portion of the plurality of images are captured after transmitting the package to the downstream station.

Embodiment 29. The system of Embodiment 28, wherein the plurality of images are applied sequentially to the device detection model, such that the device detection model outputs a sequence of detected electronic device counts associated with the interior of the package.

Embodiment 30. The system of any one of Embodiments 23-29, wherein the at least one image comprises a plurality of images, and wherein applying the at least one image to the device detection model comprises applying the plurality of images to the device detection model.

Embodiment 31. The system of Embodiment 23-29, further comprising a second image capturing device, wherein the computer-coded instructions, with the at least one processor, further cause the system to: position the package comprising the first plurality of electronic devices within the field-of-view of the second image capturing device; capture at least one second image of at least the interior of the package using the second image capturing device; apply one or more of the at least one second image to the device detection model, the device detection model is configured to output a second detected electronic device count associated with the interior of the package; receive a second expected electronic device count associated with the package; compare the second detected electronic device count and the second expected electronic device count; in the first instance where the second detected electronic device count and the second expected electronic device count are equal, activate the package handling apparatus to transmit the package to the downstream station; and in the second instance where the second detected electronic device count and the second expected electronic device count are not equal, trigger the error condition.

Embodiment 32. The system of any one of Embodiments 23-31, wherein positioning the package within the field-of-view of the first image capturing device comprises positioning the package at a first location, wherein a second location is defined downstream of the first location at the downstream station or between the first location and the downstream station, wherein the system further comprises: generating a plurality of images of the package while the package is between the first location and the second location, via the first image capturing device or a second image capturing device; and applying one or more of the plurality of images to the device detection model to generate one or more additional detected electronic device counts.

Embodiment 33. The system of any one of Embodiment 23-32, wherein the first image capturing device is positioned above a conveyor, and wherein positioning the package within the field-of-view of the first image capturing device comprises actuating the conveyor to move the package within the field-of-view of the first image capturing device.

Embodiment 34. The system of any one of Embodiments 23-33, further comprising programmatically generating a plurality of device profile data objects associated with the first plurality of electronic devices detected in the detected electronic device count and printing a device ID label for each of the first plurality of electronic devices.

Embodiment 35. The system of any one of Embodiments 23-34, further comprising masking the one or more of the at least one image to isolate the interior of the package before applying the one or more of the at least one image to the device detection model.

Embodiment 36. The system of any one of Embodiments 23-35, wherein the device detection model comprises at least one convolutional neural network.

Embodiment 37. The system of Embodiment 36, wherein the at least one convolutional neural network comprises at least 24 convolutional layers.

Embodiment 38. The system of Embodiment 36 or 37, wherein applying one or more of the at least one image to the device detection model comprises passing the one or more of the at least one image through the at least one convolutional neural network to divide one or more of the at least one image into a grid of cells and generating a set of bounding boxes and class probabilities for each cell of the grid of cells.

Embodiment 39. The system of Embodiment 38, wherein applying one or more of the at least one image to the device detection model further comprises filtering the set of bounding boxes by removing at least one lower probability bounding box overlapping at least one higher probability bounding box to generate a set of predicted bounding boxes with class labels for each electronic device in the one or more of the at least one image.

Embodiment 40. The system of any one of Embodiments 23-39, wherein a first electronic device of the first plurality of electronic devices is overlapping a second electronic device of the first plurality of electronic devices, and wherein the detected electronic device count comprises counts representing both the first electronic device and the second electronic device.

Embodiment 41. The system of any one of Embodiments 23-40, wherein in the second instance, the computer-coded instructions, with the at least one processor, further cause the system to determine an actual electronic device count and updating a training of the device detection model based on the actual electronic device count and the one or more of the at least one image.

Embodiment 42. The system of any one of Embodiments 23-41, further comprising a second image capturing device, wherein the computer-coded instructions, with the at least one processor, further cause the system to: capture at least one second image of at least the interior of the package using the second image capturing device while the package is within the field-of-view of the first image capturing device and a field-of-view of the second image capturing device; apply one or more of the at least one second image to the device detection model, wherein the device detection model outputs a second detected electronic device count associated with the interior of the package; and compare the second detected electronic device count and the detected electronic device count.

Embodiment 43. The system of any one of Embodiments 23-42, further comprising a second image capturing device defining a second field-of-view, wherein the first image capturing device is disposed at a first location and the second image capturing device is disposed at a second location, wherein the field-of-view includes a first station, and wherein the second field-of-view includes the downstream station, further causing the system to: capture at least one second image of at least the interior of the package using the second image capturing device; apply one or more of the at least one second image to the device detection model, the device detection model is configured to output a second detected electronic device count associated with the interior of the package; and compare the second detected electronic device count and the detected electronic device count to verify a same number of electronic devices in the interior of the package.

Embodiment 44. The system of any one of Embodiments 23-43, further comprising a second image capturing device defining a second field-of-view, wherein the first image capturing device is disposed at a first location and the second image capturing device is disposed at a second location upstream of the first location, wherein the field-of-view includes a first station, and wherein the second field-of-view includes an upstream station, further causing the system to: capture at least one second image of at least the interior of the package using the second image capturing device; apply one or more of the at least one second image to the device detection model, wherein the device detection model outputs a second detected electronic device count associated with the interior of the package; and store the second detected electronic device count as the expected electronic device count.

Embodiment 45. At least one non-transitory computer-readable storage medium for electronic device following operation via system, the at least one non-transitory computer-readable storage medium having computer program code stored thereon that, in execution with at least one processor, configures the computer program code to: position a package comprising a first plurality of electronic devices within a field-of-view of a first image capturing device; capture at least one image of at least an interior of the package using the first image capturing device; apply one or more of the at least one image to a device detection model, the device detection model is configured to output a detected electronic device count associated with the interior of the package; receive an expected electronic device count associated with the package; compare the detected electronic device count and the expected electronic device count; in a first instance where the detected electronic device count and the expected electronic device count are equal, activate a package handling apparatus to transmit the package to a downstream station; and in a second instance where the detected electronic device count and the expected electronic device count are not equal, trigger an error condition.

Embodiment 46. The at least one non-transitory computer-readable storage medium of Embodiment 45, the computer program code, in execution with at least one processor, further configures the computer program code to: capture a first image of at least an exterior of the package; analyze the first image to identify a package identifier; and determine the expected electronic device count based on the package identifier.

Embodiment 47. The at least one non-transitory computer-readable storage medium of Embodiment 46, wherein the package identifier is a shipping label disposed on the exterior of the package.

Embodiment 48. The at least one non-transitory computer-readable storage medium of Embodiment 46 or 47, wherein the device detection model is trained to identify a particular make or model of electronic device, the particular make or model of electronic device corresponding to a make or model of the first plurality of electronic devices.

Embodiment 49. The at least one non-transitory computer-readable storage medium of any one of Embodiments 46-48, the computer program code, in execution with at least one processor, further configures the computer program code to store one or more of the at least one image in association with the package identifier.

Embodiment 50. The at least one non-transitory computer-readable storage medium of any one of Embodiments 45-49, the computer program code, in execution with at least one processor, further configures the computer program code to capture a plurality of images including the at least one image, via the first image capturing device, wherein at least a portion of the plurality of images are captured before positioning the package within the field-of-view of the first image capturing device and at least a second portion of the plurality of images are captured after transmitting the package to the downstream station.

Embodiment 51. The at least one non-transitory computer-readable storage medium of Embodiment 50, wherein the plurality of images are applied sequentially to the device detection model, such that the device detection model outputs a sequence of detected electronic device counts associated with the interior of the package.

Embodiment 52. The at least one non-transitory computer-readable storage medium of any one of Embodiments 45-51, wherein the at least one image comprises a plurality of images, and wherein applying the at least one image to the device detection model comprises applying the plurality of images to the device detection model.

Embodiment 53. The at least one non-transitory computer-readable storage medium of any one of Embodiments 45-52, the computer program code, in execution with at least one processor, further configures the computer program code to: position the package comprising the first plurality of electronic devices within the field-of-view of a second image capturing device; capture at least one second image of at least the interior of the package using the second image capturing device; apply one or more of the at least one second image to the device detection model, the device detection model is configured to output a second detected electronic device count associated with the interior of the package; receive a second expected electronic device count associated with the package; compare the second detected electronic device count and the second expected electronic device count; in the first instance where the second detected electronic device count and the second expected electronic device count are equal, activate the package handling apparatus to transmit the package to the downstream station; and in the second instance where the second detected electronic device count and the second expected electronic device count are not equal, trigger the error condition.

Embodiment 54. The at least one non-transitory computer-readable storage medium of any one of Embodiments 45-53, wherein positioning the package within the field-of-view of the first image capturing device comprises positioning the package at a first location; wherein a second location is defined downstream of the first location at the downstream station or between the first location and the downstream station; wherein the computer program code, in execution with at least one processor, further configures the computer program code to: generate a plurality of images of the package while the package is between the first location and the second location, via the first image capturing device or a second image capturing device; and apply one or more of the plurality of images to the device detection model to generate one or more additional detected electronic device counts.

Embodiment 55. The at least one non-transitory computer-readable storage medium of any one of Embodiments 45-54, wherein the first image capturing device is positioned above a conveyor, and wherein positioning the package within the field-of-view of the first image capturing device comprises actuating the conveyor to move the package within the field-of-view of the first image capturing device.

Embodiment 56. The at least one non-transitory computer-readable storage medium of any one of Embodiments 45-55, the computer program code, in execution with at least one processor, further configures the computer program code to programmatically generate a plurality of device profile data objects associated with the first plurality of electronic devices detected in the detected electronic device count and printing a device ID label for each of the first plurality of electronic devices.

Embodiment 57. The at least one non-transitory computer-readable storage medium of any one of Embodiments 45-56, the computer program code, in execution with at least one processor, further configures the computer program code to mask the one or more of the at least one image to isolate the interior of the package before applying the one or more of the at least one image to the device detection model.

Embodiment 58. The at least one non-transitory computer-readable storage medium of any one of Embodiments 45-57, wherein the device detection model comprises at least one convolutional neural network.

Embodiment 59. The at least one non-transitory computer-readable storage medium of Embodiment 58, wherein the at least one convolutional neural network comprises at least 24 convolutional layers.

Embodiment 60. The at least one non-transitory computer-readable storage medium of Embodiments 58 or 59, wherein applying one or more of the at least one image to the device detection model comprises passing the one or more of the at least one image through the at least one convolutional neural network to divide one or more of the at least one image into a grid of cells and generating a set of bounding boxes and class probabilities for each cell of the grid of cells.

Embodiment 61. The at least one non-transitory computer-readable storage medium of Embodiment 60, wherein applying one or more of the at least one image to the device detection model further comprises filtering the set of bounding boxes by removing at least one lower probability bounding box overlapping at least one higher probability bounding box to generate a set of predicted bounding boxes with class labels for each electronic device in the one or more of the at least one image.

Embodiment 62. The at least one non-transitory computer-readable storage medium of any one of Embodiments 45-61, wherein a first electronic device of the first plurality of electronic devices is overlapping a second electronic device of the first plurality of electronic devices, and wherein the detected electronic device count comprises counts representing both the first electronic device and the second electronic device.

Embodiment 63. The at least one non-transitory computer-readable storage medium of any one of Embodiments 45-62, wherein in the second instance, the computer-coded instructions, with the at least one processor, further cause the system to determine an actual electronic device count and update a training of the device detection model based on the actual electronic device count and the one or more of the at least one image.

Embodiment 64. The at least one non-transitory computer-readable storage medium of any one of Embodiments 45-63, the computer program code, in execution with at least one processor, further configures the computer program code to: capture at least one second image of at least the interior of the package using the second image capturing device while the package is within the field-of-view of the first image capturing device and a field-of-view of a second image capturing device; apply one or more of the at least one second image to the device detection model, wherein the device detection model outputs a second detected electronic device count associated with the interior of the package; and comparing the second detected electronic device count and the detected electronic device count.

Embodiment 65. The at least one non-transitory computer-readable storage medium of any one of Embodiments 45-64, wherein the first image capturing device is disposed at a first location and a second image capturing device is disposed at a second location, wherein the field-of-view includes a first station; wherein a second field-of-view of the second image capturing device includes the downstream station; wherein the computer program code, in execution with at least one processor, further configures the computer program code to: capture at least one second image of at least the interior of the package using the second image capturing device; apply one or more of the at least one second image to the device detection model, the device detection model is configured to output a second detected electronic device count associated with the interior of the package; and compare the second detected electronic device count and the detected electronic device count to verify a same number of electronic devices in the interior of the package.

Embodiment 66. The at least one non-transitory computer-readable storage medium of any one of Embodiments 45-65, wherein the first image capturing device is disposed at a first location and a second image capturing device is disposed at a second location upstream of the first location, wherein the field-of-view includes a first station; wherein a second field-of-view of the second image capturing device includes an upstream station; wherein the computer program code, in execution with at least one processor, further configures the computer program code to: capture at least one second image of at least the interior of the package using the second image capturing device; apply one or more of the at least one second image to the device detection model, wherein the device detection model outputs a second detected electronic device count associated with the interior of the package; and store the second detected electronic device count as the expected electronic device count.

Embodiment 67. A system comprising: a plurality of stations, the plurality of stations comprising a first station and a second station; a first image capturing device comprising a first field of view that includes at least a portion of the first station, the first image capturing device configured to capture a first image of a plurality of electronic devices at the first station; a second image capturing device comprising a second field of view that includes at least a portion of the second station, the second image capturing device configured to capture a second image of the plurality of electronic devices at the second station; at least one processor; and at least one non-transitory memory including computer-coded instructions thereon; the computer-coded instructions, with the at least one processor, cause the system to: apply the first image to one or more device detection models to generate a first detected electronic device count; apply the second image to the one or more device detection models to generate a second detected electronic device count; and compare the first detected electronic device count and the second detected electronic device count.

Embodiment 68. The system of Embodiment 67, further comprising: at least one code reader at or upstream of the first station and the second station, the at least one code reader configured to capture a decodable indicia associated with a package of the plurality of electronic devices, wherein the computer-coded instructions, with the at least one processor, further cause the system to: determine an expected electronic device count based on the decodable indicia; and compare the expected electronic device count to the first detected electronic device count or the second detected electronic device count.

Embodiment 69. The system of Embodiment 68, wherein in an instance in which the first detected electronic device count does not equal the second detected electronic device count, the computer-coded instructions, with the at least one processor, further cause the system to: generate an error condition; and activate a package handling apparatus to separate the package from a process flow.

Embodiment 70. The system of any one of Embodiments 67-69, wherein the computer-coded instructions, with the at least one processor, further cause the system to: store a predicted location associated with each of the plurality of electronic devices, wherein the predicted location is based on the first detected electronic device count or the second detected electronic device count.

Embodiment 71. The system of Embodiment 70, wherein storing the predicted location associated with each of the plurality of electronic devices comprises incrementing a counter associated with at least one of the first station or the second station in memory based respectively on the first detected electronic device count or the second detected electronic device count.

### Conclusion

Although example processing systems have been described above, implementations of the subject matter and the functional operations described herein can be implemented in other types of digital electronic circuitry, or in computer software, firmware, or hardware, including the structures disclosed in this specification and their structural equivalents, or in combinations of one or more of them. Embodiments of the subject matter described herein can be implemented as one or more computer programs, e.g., one or more modules of computer program instructions, encoded on computer storage medium for execution by, or to control the operation of, information/data processing apparatus. Alternatively, or in addition, the program instructions can be encoded on an artificially generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

At least portions of the operations described herein can be implemented as operations performed by an information/data processing apparatus on information/data stored on one or more computer-readable storage devices or received from other sources.

The term “data processing apparatus” and similar terms encompass all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software program, software, software application, script, computer executable instructions, computer program code, code, and/or similar terminology) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A computer program can include electronically transmitted computer-executable instructions configured to cause a receiving device to perform one or more functions, including executing one or more pre-programmed functions of the recipient device and/or executing code received from the transmitting device. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output, which programmable processors may be incorporated into or otherwise in communication with the one or more apparatuses disclosed herein. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

1. A computer-implemented method for determining a number of electronic devices, wherein the computer-implemented method comprises:
positioning a package comprising a first plurality of electronic devices within a field-of-view of a first image capturing device;
capturing at least one image of at least an interior of the package using the first image capturing device;
applying one or more of the at least one image to a device detection model, the device detection model is configured to output a detected electronic device count associated with the interior of the package;
receiving an expected electronic device count associated with the package;
comparing the detected electronic device count and the expected electronic device count;
in a first instance where the detected electronic device count and the expected electronic device count are equal, activate a package handling apparatus to transmit the package to a downstream station; and
in a second instance where the detected electronic device count and the expected electronic device count are not equal, trigger an error condition.

2. The computer-implemented method of claim 1, further comprising:
capturing a first image of at least an exterior of the package;
analyzing the first image to identify a package identifier; and
determining the expected electronic device count based on the package identifier.

3. (canceled)

4. The computer-implemented method of claim 2, wherein the device detection model is trained to identify a particular make or model of electronic device, the particular make or model of electronic device corresponding to a make or model of the first plurality of electronic devices.

5. (canceled)

6. The computer-implemented method of claim 1, further comprising capturing a plurality of images including the at least one image, via the first image capturing device, wherein at least a portion of the plurality of images are captured before positioning the package within the field-of-view of the first image capturing device and at least a second portion of the plurality of images are captured after transmitting the package to the downstream station.

7. The computer-implemented method of claim 6, wherein the plurality of images are applied sequentially to the device detection model, such that the device detection model outputs a sequence of detected electronic device counts associated with the interior of the package.

8. (canceled)

9. The computer-implemented method of claim 1, further comprising a second image capturing device, wherein the computer-implemented method further comprises:
positioning the package comprising the first plurality of electronic devices within the field-of-view of the second image capturing device;
capturing at least one second image of at least the interior of the package using the second image capturing device;
applying one or more of the at least one second image to the device detection model, the device detection model is configured to output a second detected electronic device count associated with the interior of the package;
receiving a second expected electronic device count associated with the package;
comparing the second detected electronic device count and the second expected electronic device count;
in the first instance where the second detected electronic device count and the second expected electronic device count are equal, activate the package handling apparatus to transmit the package to the downstream station; and
in the second instance where the second detected electronic device count and the second expected electronic device count are not equal, trigger the error condition.

10. The computer-implemented method of claim 1, wherein positioning the package within the field-of-view of the first image capturing device comprises positioning the package at a first location, wherein a second location is defined downstream of the first location at the downstream station or between the first location and the downstream station, wherein the computer-implemented method further comprises:
generating a plurality of images of the package while the package is between the first location and the second location via the first image capturing device or a second image capturing device; and
applying one or more of the plurality of images to the device detection model to generate one or more additional detected electronic device counts.

11. The computer-implemented method of claim 1,
wherein the first image capturing device is positioned above a conveyor, and
wherein positioning the package within the field-of-view of the first image capturing device comprises actuating the conveyor to move the package within the field-of-view of the first image capturing device.

12. The computer-implemented method of claim 1, further comprising programmatically generating a plurality of device profile data objects associated with the first plurality of electronic devices detected in the detected electronic device count and printing a device ID label for each of the first plurality of electronic devices.

13. The computer-implemented method of claim 1, further comprising masking the one or more of the at least one image to isolate the interior of the package before applying the one or more of the at least one image to the device detection model.

14. The computer-implemented method of claim 1, wherein the device detection model comprises at least one convolutional neural network.

15. (canceled)

16. The computer-implemented method of claim 14, wherein applying one or more of the at least one image to the device detection model comprises passing the one or more of the at least one image through the at least one convolutional neural network to divide one or more of the at least one image into a grid of cells and generating a set of bounding boxes and class probabilities for each cell of the grid of cells.

17. The computer-implemented method of claim 16, wherein applying one or more of the at least one image to the device detection model further comprises filtering the set of bounding boxes by removing at least one lower probability bounding box overlapping at least one higher probability bounding box to generate a set of predicted bounding boxes with class labels for each electronic device in the one or more of the at least one image.

18. The computer-implemented method of claim 1, wherein a first electronic device of the first plurality of electronic devices is overlapping a second electronic device of the first plurality of electronic devices, and wherein the detected electronic device count comprises counts representing both the first electronic device and the second electronic device.

19. The computer-implemented method of claim 1, wherein in the second instance, the method further comprises determining an actual electronic device count and updating a training of the device detection model based on the actual electronic device count and the one or more of the at least one image.

20. The computer-implemented method of claim 1, further comprising
a second image capturing device, wherein the computer-implemented method further comprises:
capturing at least one second image of at least the interior of the package using the second image capturing device while the package is within the field-of-view of the first image capturing device and a field-of-view of the second image capturing device;
applying one or more of the at least one second image to the device detection model, wherein the device detection model outputs a second detected electronic device count associated with the interior of the package; and
comparing the second detected electronic device count and the detected electronic device count.

21. The computer-implemented method of claim 1, further comprising a second image capturing device defining a second field-of-view, wherein the first image capturing device is disposed at a first location and the second image capturing device is disposed at a second location, wherein the field-of-view includes a first station, and wherein the second field-of-view includes the downstream station, the method further comprising:
capturing at least one second image of at least the interior of the package using the second image capturing device;
applying one or more of the at least one second image to the device detection model, the device detection model is configured to output a second detected electronic device count associated with the interior of the package; and
comparing the second detected electronic device count and the detected electronic device count to verify a same number of electronic devices in the interior of the package.

22. The computer-implemented method of claim 1, further comprising a second image capturing device defining a second field-of-view, wherein the first image capturing device is disposed at a first location and the second image capturing device is disposed at a second location upstream of the first location, wherein the field-of-view includes a first station, and wherein the second field-of-view includes an upstream station, the method further comprising:
capturing at least one second image of at least the interior of the package using the second image capturing device;
applying one or more of the at least one second image to the device detection model, wherein the device detection model outputs a second detected electronic device count associated with the interior of the package; and
storing the second detected electronic device count as the expected electronic device count.

23. A system comprising at least one processor, and at least one non-transitory memory including computer-coded instructions thereon; the computer-coded instructions, with the at least one processor, cause the system to:
position a package comprising a first plurality of electronic devices within a field-of-view of a first image capturing device;
capture at least one image of at least an interior of the package using the first image capturing device;
apply one or more of the at least one image to a device detection model, the device detection model is configured to output a detected electronic device count associated with the interior of the package;
receive an expected electronic device count associated with the package;
compare the detected electronic device count and the expected electronic device count;
in a first instance where the detected electronic device count and the expected electronic device count are equal, activate a package handling apparatus to transmit the package to a downstream station; and
in a second instance where the detected electronic device count and the expected electronic device count are not equal, trigger an error condition.

24.-44. (canceled)

45. At least one non-transitory computer-readable storage medium for electronic device following operation via system, the at least one non-transitory computer-readable storage medium having computer program code stored thereon that, in execution with at least one processor, configures the computer program code to:
position a package comprising a first plurality of electronic devices within a field-of-view of a first image capturing device;
capture at least one image of at least an interior of the package using the first image capturing device;
apply one or more of the at least one image to a device detection model, the device detection model is configured to output a detected electronic device count associated with the interior of the package;
receive an expected electronic device count associated with the package;
compare the detected electronic device count and the expected electronic device count;
in a first instance where the detected electronic device count and the expected electronic device count are equal, activate a package handling apparatus to transmit the package to a downstream station; and
in a second instance where the detected electronic device count and the expected electronic device count are not equal, trigger an error condition.

46.-71. (canceled)
